(19) United States
(12) Patent Application Publication
(10) Pub. No.: US 2013/0172603 A1
(43) Pub. Date: Jul. 4, 2013

(54) METHOD FOR PRODUCING A SHELL CATALYST AND SHELL CATALYST

(71) Applicants: Alfred Hagemeyer, Sunnyvale, CA (US); Gerhard Mestl, Munchen (DE); Peter Scheck, Gilching (DE); Alice Kyriopoulos, Darmstadt (DE); Carolin Fischer, Rosenheim (DE)

(72) Inventors: Alfred Hagemeyer, Sunnyvale, CA (US); Gerhard Mestl, Munchen (DE); Peter Scheck, Gilching (DE); Alice Kyriopoulos, Darmstadt (DE); Carolin Fischer, Rosenheim (DE)

(73) Assignee: SÜD-CHEMIE IP GMBH & CO. KG, MUNCHEN (DE)

(21) Appl. No.: 13/808,712

(22) PCT Filed: Jul. 7, 2011
(86) PCT No.: PCT/EP11/61484

§ 371 Date: Mar. 18, 2013

(30) Foreign Application Priority Data
Jul. 8, 2010 (DE) 10 2010 026 462.8

(51) Int. Cl. B01J 21/16

(52) U.S. Cl. CPC B01J 21/16
USPC 560/261; 502/300; 502/84; 502/242; 502/330

(57) ABSTRACT

A method for producing a shell catalyst is provided which comprises a porous catalyst support shaped body with an outer shell in which at least one transition metal in metal form is contained, comprising: providing catalyst support shaped bodies; applying a transition-metal precursor compound to an outer shell of the catalyst support shaped bodies; and converting the metal component of the transition-metal precursor compound into the metal form by reduction in a process gas at a temperature of from 50 to 500° C., wherein the temperature and the duration of the reduction are chosen such that the product of reduction temperature in ° C. and reduction time in hours lies in a range of from 50 to 5000, more preferably 80 to 2500, further preferably 80 to 2000, and more preferably 100 to 1500.

The present invention relates to a method for producing a shell catalyst which comprises a porous catalyst support shaped body with an outer shell in which at least one transition metal in metal form is contained, a shell catalyst and a use of a shell catalyst.

Supported transition-metal catalysts in the form of shell catalysts and also methods for their production are known in the state of the art. The catalytically active species—often also the promoters—are contained in shell catalysts only in an outer area (shell) of greater or lesser width of a catalyst support shaped body, i.e. they do not fully penetrate the catalyst support shaped body (cf. for example EP 565 952 A1, EP 634 214 A1, EP 634 209 A1 and EP 634 208 A1). With shell catalysts, a more selective reaction control is possible in many cases than with catalysts in which the support is loaded into the core of the support with the catalytically active species (“impregnated through”).

Vinyl acetate monomer (VAM) for example is currently produced predominantly by means of shell catalysts in high selectivity. The great majority of the shell catalysts used at present for producing VAM are shell catalysts with a Pd/Au shell on a porous amorphous aluminosilicate support, formed as a sphere, based on natural sheet silicates, wherein the supports are impregnated through with potassium acetate as promoter. In the Pd/Au system of these catalysts, the active metals Pd and Au are probably not present in the form of metal particles of the respective pure metal, but rather in the form of Pd/Au-alloy particles of possibly different composition, although the presence of unalloyed particles cannot be ruled out.

VAM shell catalysts are usually produced by impregnation by the so-called wet chemical route in which the catalyst support is steeped in solutions of corresponding metal compounds, for example by dipping the support into the solutions, or by means of the incipient wetness method (pore-filling method) in which the support is loaded with a volume of solution corresponding to its pore volume, e.g. by spraying. After the application and fixing of the metal compounds, they are treated with a reducing agent at low temperatures and thus converted into the metal form. For example, within the framework of a gas-phase reduction, ethylene, hydrogen or nitrogen can be used as reducing agents at temperatures of 150° C. and above.

The Pd/Au shell of a VAM shell catalyst is produced for example by first steeping the catalyst support shaped body in a first step in an Na₂PdCl₄ solution and then in a second step fixing the Pd component with NaOH solution onto the catalyst support in the form of a Pd-hydroxide compound. In a subsequent, separate third step, the catalyst support is then steeped in an NaAuCl₄ solution and then the Au component is likewise fixed by means of NaOH. It is also possible for example to firstly steep the support in lye and then apply the precursor compounds to the thus-pretreated support. After the fixing of the noble-metal components to the catalyst support, the loaded catalyst support is then very largely washed free of chloride and Na ions, then dried and finally reduced with ethylene at 150° C. The produced Pd/Au shell is usually approximately 100 to 500 μm thick, wherein normally the smaller the thickness of its shell, the higher the product selectivity of a shell catalyst.

Usually, the catalyst support loaded with the noble metals is then loaded with a promoter, e.g. potassium acetate, after the fixing or reducing step, wherein, rather than the loading with potassium acetate taking place only in the outer shell loaded with noble metals, the catalyst support is completely impregnated through with the promoter.

According to the state of the art, the active metals Pd and Au, starting from chloride compounds in the area of a shell of the support, are applied to same by means of steeping. However, this technique has reached its limits as regards minimum shell thicknesses. The smallest achievable shell thickness of correspondingly produced VAM catalysts is at best approx. 100 μm and it is not foreseen that even thinner shells can be obtained by means of steeping. In addition, the catalysts produced by means of steeping have a relatively large average dispersion of the noble-metal particles, which can have a disadvantageous effect in particular on the activity of the catalyst.

Furthermore, a method is known for producing a shell catalyst using a device which is set up to cause a circulation of the catalyst support shaped bodies, by means of a process gas. The application and the reduction of precursors of catalytically active transition metals can thus take place during the circulation of the shaped bodies. By means of the process gas, e.g. a fluid bed or a fluidized bed of catalyst support shaped bodies is produced in which the shaped bodies are circulated. Supported transition-metal catalysts can thereby be produced which have a relatively small shell thickness.

The object of the present invention is to provide a shell catalyst with an improved selectivity and activity, and a corresponding shell catalyst production method.

This object is achieved by a method for producing a shell catalyst which comprises a porous catalyst support shaped body with an outer shell in which at least one transition metal in metal form is contained, using a device which is set up to cause a circulation of the catalyst support shaped bodies by means of a process gas, comprising
providing catalyst support shaped bodies, comprising charging the device with the catalyst support shaped bodies and causing a circulation of the catalyst support shaped bodies by means of the process gas;
applying a transition-metal precursor compound to an outer shell of the catalyst support shaped bodies, comprising spraying the outer shell of the circulating catalyst support shaped bodies with a solution containing the transition-metal precursor compound at a temperature of from 60 to 90° C.; and
following the application, converting the metal component of the transition-metal precursor compound into the metal form by reduction in the process gas at a temperature of from 50° C. to 150° C., preferably 50° C. to 140° C., more preferably 80° C. to 120° C., wherein the temperature and the duration of the reduction are chosen such that the product of reduction temperature in ° C. and reduction time in hours lies in a range of from 50 to 1500.

The method is thus carried out by providing catalyst support shaped bodies, applying a transition-metal precursor compound to an outer shell of the catalyst support shaped bodies, and converting the metal component of the transition-metal precursor compound into the metal form by reduction in a process gas at a temperature of from approximately 50° C. to approximately 500° C., wherein the temperature and the duration of the reduction are chosen such that the product of reduction temperature in ° C. and reduction time in hours lies in a range of from 50 to 5000, preferably 60 to 2500, more preferably 80 to 2500, further preferably 80 to 2000, and more preferably 100 to 1500. The catalyst support shaped body is also called catalyst support or shaped body here.

Furthermore, the object is achieved by a shell catalyst that can be or is obtained by the method according to one of the embodiments described here, as well as by a use of a shell catalyst according to one of the embodiments described here in a method for producing vinyl acetate monomer.

A further solution of the problem includes a use of a device which is set up to cause a circulation of the catalyst support shaped bodies by means of a process gas, for carrying out a method for producing a shell catalyst according to an embodiment described here or in the production of a shell catalyst according to an embodiment described here.

Surprisingly, it has been established that shell catalysts with a high activity and selectivity can be produced with the method according to the invention. In particular, the reduction of the metal component of the transition-metal precursor compound at temperatures of from approximately 50° C. to approximately 500° C. leads to beneficial properties of the shell catalysts.

The invention makes it possible for example for the activity and the selectivity of a shell catalyst to be set according to requirements, e.g. by choosing a suitable temperature during the reduction of the metal precursor compound, and/or by setting a suitable thickness of the shell of the shell catalyst. For example, a lower activity and/or a higher selectivity of the finished shell catalyst can be achieved by a higher reduction temperature. Furthermore, supported transition-metal catalysts with a relatively small shell thickness can be produced.

In an embodiment, the reduction of the metal component of the transition-metal precursor compound takes place in the process gas in a temperature range selected from the ranges: from 50° C. to 300° C., from 60° C. to 250° C., from 80° C. to 250° C., from 80° C. to 200° C., and from 100° C. to 150° C.

According to an embodiment, the reduction can be carried out for 1 to 10 hours, preferably for 5 hours. According to further embodiments of the method, the quotient T/t of reduction temperature T in ° C. and reduction time t in hours lies in a range of from 5 to 500, preferably 5 to 300, more preferably 8 to 200, further preferably 10 to 150 or 12 to 180. Particularly preferably, the quotient T/t of reduction temperature T in ° C. and reduction time t in hours lies in the range of from 20 to 30 or 35 to 450. In addition, in embodiments, the reduction can be carried out with reciprocally correlated temperature and reduction duration.

In particular, the reduction of the metal component of the transition-metal precursor compound under inert gas at temperatures above 250° C., e.g. from 350° C. to 450° C., leads to beneficial properties of the shell catalysts. In addition, in particular the reduction of the metal component of the transition-metal precursor compound under forming gas at temperatures of from 50° C. to 300° C., preferably from 80° C. to 250° C., more preferably from 80° C. to 200° C., most preferably approximately 100° C. to 150° C., results in beneficial properties of the shell catalysts produced.

According to embodiments of the method, the application of the transition-metal precursor compound takes place by spraying with a solution containing the transition-metal precursor compound at room temperature. Impregnated catalyst precursors form. Particularly beneficial properties of the shell catalysts produced in this way are achieved in particular by reducing the metal component of the transition-metal precursor compound under forming gas at temperatures of from 50° C. to 500° C., preferably 50 to 300° C. or from 100° C. to 150° C., more preferably 50° C. to 140° C., more preferably 80° C. to 120° C., and under inert gas in a preferred temperature range of from 350° C. to 450° C.

In other embodiments, the application of the transition-metal precursor compound can take place by spraying with a solution containing the transition-metal precursor compound and a solvent at temperatures greater than room temperature, for example approximately 50° C. to approximately 120° C., preferably approximately 60° C. to approximately 100° C., particularly preferably approximately 60° C. to approximately 90° C., and accompanied by continuous evaporation of the solvent. So-called “coated” catalyst precursors are thereby produced. Particularly beneficial properties of the shell catalysts produced in this way are obtained in particular by reducing the metal component of the transition-metal precursor compound at temperatures of from 50° C. to 500° C., preferably from 50° C. to 300° C., more preferably from 80° C. to 250° C., more preferably from 80° C. to 200° C., most preferably approximately 100° C. to 150° C. Particularly preferably, the reduction takes place at a temperature of from 50° C. to 150° C., preferably 50° C. to 140° C., more preferably 80° C. to 120° C. If the reduction of the metal component of the transition-metal precursor compound of coated catalyst precursors is carried out under inert gas, a particularly desired activity and selectivity of the final shell catalyst can be achieved with a temperature range of from 120° C. to 350° C., e.g. 150° C. to 350° C. or 150° C. to 280° C. If the reduction of the metal component of the transition-metal precursor compound of coated catalyst precursors is carried out under forming gas, a temperature range of from 120° C. to 180° C. and more preferably of approximately 150° C. can result in a particularly desired activity and selectivity of the finished shell catalyst. The spraying with the solution containing the transition-metal precursor compound and a solvent and the continuous evaporation of the solvent can take place during a circulation of the catalyst shaped bodies.

According to embodiments, the reduction of the metal component of the transition-metal precursor compound can be carried out with reciprocally correlated temperature and reduction duration. The effect of a high reduction temperature with short reduction duration on the activity and/or selectivity of the catalyst to be produced can namely also be achieved for example by reduction at a comparatively low temperature and longer reduction duration.

For example, the reduction can be carried out with the process gas, e.g. forming gas or inert gas, with reciprocally correlated temperature and reduction duration in a temperature range of from approx. 50° C. to approx. 500° C., preferably 70 to 450° C., in particular at a temperature of from 50° C. to 250° C. or 50° C. to 150° C., preferably 50° C. to 140° C., more preferably 80° C. to 120° C. and a range of the reduction duration of from approx. 10 hours to approx. 1 hour.

For the case of impregnated catalyst precursors, according to an example, the reduction can take place with reciprocally correlated temperature and reduction duration at 400° C. with a reduction duration of 5 hours in order to obtain a particularly desired activity and selectivity of the finished shell catalyst. Even at 500° C. with a shortened reduction duration of 1 hour or at 250° C. with a lengthened reduction duration of 10 hours, the method according to the invention starting from impregnated catalyst precursors leads to the desired effect.

In other examples, starting from coated catalyst precursors, the reduction can be carried out with the process gas with reciprocally correlated temperature and reduction duration in a temperature range of from 50° C. to 500° C. and a range of the reduction duration of from 10 hours to 1 hour. For the case of coated catalyst precursors, according to an example, the reduction can take place at approx. 150° C. with a reduction duration of from approx. 2 to 10 hours, e.g. 4 hours, in order to obtain a particularly desired activity and selectivity of the finished shell catalyst. Even at approx. 250° C. with a shortened reduction duration in the range of from 1 to 5 hours, the method according to the invention starting from coated catalyst precursors leads to the desired effect.

In an embodiment, the process gas is a gas which is selected from the group which consists of an inert gas, a gas mixture of an inert gas and a component with a reductive effect, and forming gas. Furthermore, in the method according to one of the embodiments described here, the application of the transition-metal precursor compound and the conversion of the transition-metal precursor compound into the metal form can take place at the same time or one after the other.

In embodiments of the method, during the application of the transition-metal precursor compound and/or during the conversion of the metal component of the transition-metal precursor compound into the metal form, a circulation of the catalyst support shaped bodies takes place, e.g. by means of the process gas and/or another gas. Supported transition-metal catalysts can thereby be produced which have a relatively small shell thickness, e.g. a thickness smaller than 300 μm to a thickness smaller than 150 μm. Furthermore, a particularly uniform deposition of the solution of the transition-metal precursor compound onto the catalyst supports can be made possible.

In embodiments of the method or the use of a device, the catalyst support shaped bodies can circulate elliptically or toroidally during the circulation, the circulation can take place in at least one fluid bed or in at least one fluidized bed.

According to embodiments described here, the method can take place using a device which is set up to cause a circulation of the catalyst support shaped bodies by means of the process gas, wherein the provision comprises charging the device with the catalyst support shaped bodies and causing a circulation of the catalyst support shaped bodies by means of the process gas, the application comprises impregnating an outer shell of the catalyst support shaped bodies with the transition-metal precursor compound by spraying the circulating catalyst support shaped bodies with a solution containing the transition-metal precursor compound.

Furthermore, the device can be set up to provide the temperatures according to the invention during the conversion of the metal component of the transition-metal precursor compound into the metal form, e.g. by heating the process gas and/or the catalyst support shaped bodies. The application of the transition-metal precursor compound to the circulating shaped bodies can take place for example at approximately 60 or 70° C. to approximately 90° C. in order to obtain particularly suitable shells of the shell catalysts, while the reduction of the metal component can be carried out at temperatures of from approximately 50° C. to approximately 500° C., preferably approximately 50° C. to approximately 150° C. or approximately 50° C. to approximately 140° C., more preferably approximately 80° C. to approximately 120° C.

If according to an embodiment the process gas is an inert gas and the conversion of the metal component of the transition-metal precursor compound into the metal form takes place at approximately 350° C. to 450° C., e.g. at 450° C., shell catalysts with particularly high selectivity and activity are obtained in a method which effects a circulation of the catalyst support shaped bodies. If according to an embodiment the process gas is a process gas with a reductive effect, e.g. forming gas, and the conversion of the metal component of the transition-metal precursor compound into the metal form is carried out, e.g. accompanied by circulation of the catalyst support shaped bodies, by reduction with the process gas with a reductive effect at a temperature above 350° C., e.g. between 380° C. and 420° C., or of from approximately 150° C. to approximately 450° C., preferably 200° C. to 400° C. and more preferably 250° C. to 350° C., shell catalysts with particularly high selectivity and activity are likewise obtained.

If the shell catalyst to be produced is to contain several different transition metals in the shell, for example several active metals or an active metal and a promoter metal, then the catalyst support shaped body can for example be subjected correspondingly frequently to the method according to the invention. Alternatively, the method according to the invention can also be carried out with mixed solutions which contain transition-metal precursor compounds of different metals. Furthermore, the method according to the invention can be carried out by spraying the catalyst supports with several solutions of precursor compounds of different metals at the same time.

In an embodiment, the method is thus carried out with a process gas with a reductive effect. It can thereby be made possible, for example if the method is carried out accompanied by circulation of the shaped bodies by means of the process gas, that the metal component of the transition-metal precursor compound is reduced to the metal immediately after deposition onto the catalyst support and is thereby fixed to the support.

The process gas with a reductive effect that can be used in the method according to the invention is for example a gas mixture, comprising an inert gas as well as a component with a reductive effect. The reduction speed and thus also, to a certain extent, the shell thickness can be set inter alia via the proportion in the gas mixture of the component with a reductive effect.

In an embodiment, a gas selected from the group consisting of nitrogen, carbon dioxide and the noble gases, preferably helium and argon, or mixtures of two or more of the above-named gases is used as inert gas.

The component with a reductive effect is normally to be selected according to the nature of the metal component to be reduced, but preferably selected from the group of gases or vaporable liquids consisting of ethylene, hydrogen, CO, NH₃, formaldehyde, methanol, formic acid and hydrocarbons, or is a mixture of two or more of the above-named gases/liquids.

In particular in respect of noble metals as metal components to be reduced, gas mixtures of hydrogen with nitrogen or argon can be preferred, preferably with a hydrogen content between 1 vol.-% and 15 vol.-%. The process gas with a reductive effect can for example be forming gas, i.e. a gas mixture of N₂ and H₂. For example, the method is carried out with hydrogen (5 vol.-%) in nitrogen as process gas at a temperature of for instance above approximately 350° C. over a period of for example 5 hours.

In embodiments, e.g. in which the method is carried out with a process gas with a reductive effect, the steps of providing catalyst shaped bodies and of applying thereto a transition-metal precursor compound can take place by the wet chemical route, i.e. by impregnation. For example, the catalyst support is steeped in solutions of corresponding metal compounds for example by dipping the support into the solutions or by means of the incipient wetness method (pore-filling method).

The Pd/Au shell of a VAM shell catalyst is produced for example by impregnation, by first steeping the catalyst support shaped body in a first step in an Na₂PdCl₄ solution and then in a second step fixing the Pd component with a basic solution or lye onto the catalyst support in the form of a Pd-hydroxide compound. In a subsequent, separate third step, the catalyst support is then steeped in an NaAuCl₄ solution and then the Au component is likewise fixed by means of a basic solution or lye. It is also possible for example to firstly steep the support in lye and then apply the precursor compounds to the thus-pretreated support. After the fixing of the noble-metal components to the catalyst support, the loaded catalyst support is then very largely washed free of chloride and Na ions, then dried. Finally, a reduction of the metal component of the Pd/Au precursor compound according to embodiments described here follows.

The provision of catalyst shaped bodies and the application thereto of a transition-metal precursor compound can also take place by another type of impregnation, e.g. according to the following procedure: For the production of a Pd/Au shell of a VAM shell catalyst, for example Na₂PdCl₄ and NaAuCl₄ are brought into solution with H₂O, the catalyst support shaped bodies are rotated therein, e.g. in a Rotavapor. In addition, a fixing with basic solution, e.g. with NaOH, takes place without intermediate drying. The basic solution can be applied to the shaped body before or after impregnation. Finally, the impregnated shaped bodies are washed, dried and reduced with for example the process gas with a reductive effect.

In embodiments, alkali hydroxides, alkali bicarbonates, alkali carbonates, alkali silicates, or mixtures can be used as basic solution. Potassium hydroxide and sodium hydroxide, sodium silicate and potassium silicate are preferably used.

Usually, the catalyst support loaded with the noble metals is then loaded with a promoter, e.g. potassium acetate, after the fixing or reducing step, wherein, rather than the loading with potassium acetate being able to take place only in the outer shell loaded with noble metals, the catalyst support can be completely impregnated through with the promoter.

If a circulation of the shaped bodies is carried out in the method of an embodiment, the application and/or the reduction of precursors of catalytically active transition metals can take place during the circulation of the shaped bodies. For example, the method is carried out accompanied by circulation of the shaped bodies with e.g. nitrogen as process gas. The application of the transition-metal precursor compound is carried out e.g. at approx. 50° C. to approx. 150° C. accompanied by circulation of the shaped bodies and, once the application is over, the temperature is set to the reduction temperature, e.g. to 150° C., in order to effect the reduction. The application of the transition-metal precursor compound can also take place without circulation of the shaped bodies and the circulation of the shaped bodies is carried out only for the reduction in the process gas. Moreover, the reduction of the transition-metal precursor compound can take place without circulation of the shaped bodies and the application of the transition-metal precursor compound can be carried out during a circulation of the shaped bodies.

According to an embodiment, the process gas is an inert gas and the conversion of the metal component of the transition-metal precursor compound into the metal form takes place at above 350° C., e.g. at approximately 450° C., in a method using a device which effects a circulation of the catalyst support shaped bodies. Thus, the application of the transition-metal compound and the reduction of the metal component can be carried out at the same time, but also one after the other.

In another embodiment, the conversion of the metal component of the transition-metal precursor compound into the metal form is carried out in the process gas, e.g. at a temperature in the range of from 150° C. to 450° C., in a stationary fixed bed, to produce coated shaped bodies the application of the transition-metal precursor compound can take place accompanied by circulation.

In an embodiment, the process gas is a process gas with a reductive effect, e.g. forming gas, and the conversion of the metal component of the transition-metal precursor compound into the metal form is carried out by reduction with the process gas with a reductive effect at a temperature in the range of from 50° C. to 500° C., e.g. between 120° C. and 180° C., for example at approximately 150° C. If this embodiment is carried out without circulation, a device can be used which effects no circulation of the catalyst support shaped bodies, but is set up to provide the temperatures according to the invention.

The terms “catalyst support shaped body”, “catalyst support”, “shaped body” and “support” are used synonymously within the framework of the present invention.

In an embodiment of the method, the circulation of the catalyst support shaped bodies is effected by the production of at least one fluid bed or at least one fluidized bed of catalyst support shaped bodies by means of a gas and/or the process gas. A particularly uniform deposition of the solution of the transition-metal precursor compound onto the catalyst supports can thereby be made possible.

Suitable fluid bed units or fluidized bed units for carrying out the methods according to the invention according to embodiments described here are known in the state of the art and sold e.g. by Heinrich Brucks GmbH (Alfeld, Germany), ERWEKA GmbH (Heusenstamm, Germany), Stechel (Germany), DRIAM Anlagenbau GmbH (Eriskirch, Germany), Glatt GmbH (Binzen, Germany), G. S. Divisione Verniciatura (Osteria, Italy), HOFER-Pharma Maschinen GmbH (Weil am Rhein, Germany), L. B. Bohle Maschinen+Verfahren GmbH (Enningerloh, Germany), Lödige Maschinenbau GmbH (Paderborn, Germany), Manesty (Merseyside, United Kingdom), Vector Corporation (Marion, Iowa, USA), Aeromatic-Fielder AG (Bubendorf, Switzerland), GEA Process Engineering (Hampshire, United Kingdom), Fluid Air Inc. (Aurora, Ill., USA), Heinen Systems GmbH (Varel, Germany), Hüttlin GmbH (Steinen, Germany), Umang Pharmatech Pvt. Ltd. (Marharashtra, India) and Innojet Technologies (Lörrach, Germany).

According to an embodiment of the method according to the invention, for the circulation by means of a gas or the process gas a fluidized bed of catalyst support shaped bodies in which the shaped bodies circulate elliptically or toroidally, preferably toroidally, is produced. A particularly uniform deposition of the solutions to be deposited is thereby made possible, with the result that shell catalysts with a particularly uniform shell thickness can be obtained according to this embodiment. It can be that the elliptically or toroidally circulating shaped bodies circulate at a speed of from 1 to 50 cm/s, preferably at a speed of from 3 to 30 cm/s and by preference at a speed of from 5 to 20 cm/s.

Fluidized bed devices for carrying out embodiments of the method according to the invention are described for example in WO 2006/027009 A1, DE 102 48 116 B3, EP 0 370 167 A1, EP 0 436 787 B1, DE 199 04 147 A1, DE 20 2005 003 791 U1, the contents of which are incorporated into the present invention through reference. Fluidized bed devices which are particularly suitable for carrying out embodiments of the method according to the invention are sold by Innojet Technologies under the names Innojet® Ventilus or Innojet® AirCoater. These devices comprise a cylindrical container with a fixedly and immovably installed container bottom in the centre of which a spraying nozzle is mounted in an example for producing a spray mist. The bottom consists of circular plates arranged in steps above each other. In these devices, a gas flows horizontally into the container between the individual plates eccentrically, with a circumferential flow component, outwardly towards the container wall. So-called air-glide layers form on which the catalyst support shaped bodies are first transported outwardly towards the container wall. In the present example, a perpendicularly oriented gas stream which deflects the catalyst supports upwards is installed outside along the container wall. Having reached the top, the catalyst supports fall on a more or less tangential path back towards the centre of the bottom, in the course of which they pass through the spray mist of the nozzle. After passing through the spray mist, the described movement process begins again. The described gas guiding provides the basis for a largely homogeneous, toroidal fluidized-bed-like circulating movement of the catalyst supports.

Unlike a conventional fluid bed, the effect of the combined action of the spraying of the shaped bodies in the spray mist with the elliptical or toroidal movement of the catalyst supports in the fluidized bed is that the individual catalyst supports pass through the spraying nozzle at an approximately identical frequency. In addition, such a circulation process also ensures that the individual catalyst supports rotate about their own axis, for which reason the catalyst supports can be impregnated particularly evenly.

According to an embodiment of the method according to the invention, the catalyst support shaped bodies circulate in the fluidized bed elliptically or toroidally, preferably toroidally. To give an idea of how the shaped bodies move in the fluidized bed, it may be stated that in the case of “elliptical circulation” the catalyst support shaped bodies move in the fluidized bed in a vertical plane on an elliptical path, the size of the major and minor axis changing. In the case of “toroidal circulation” the catalyst support shaped bodies move in the fluidized bed in the vertical plane on an elliptical path, the size of the major and minor axis changing, and in the horizontal plane on a circular path, the size of the radius changing. On average, the shaped bodies move in the case of “elliptical circulation” in the vertical plane on an elliptical path, in the case of “toroidal circulation” on a toroidal path, i.e. a shaped body covers the surface of a torus helically with a vertically elliptical section.

To produce a catalyst support shaped body fluidized bed in which the catalyst support shaped bodies circulate elliptically or toroidally in a manner that is simple, in terms of process engineering, and thus inexpensive, it is provided, according to an embodiment of the method according to the invention, that the device comprises a process chamber with a bottom and a side wall, wherein the gas and/or process gas is fed, with a substantially horizontal movement component aligned radially outwards, into the process chamber through the bottom of the process chamber, the bottom being constructed for example of several overlapping annular guide plates laid one over another between which annular slots are formed.

Because gas and/or process gas is fed into the process chamber with a horizontal movement component aligned radially outwards, an elliptical circulation of the catalyst supports in the fluidized bed is brought about. If the shaped bodies are to circulate toroidally in the fluidized bed, the shaped bodies can also be subjected to a further circumferential movement component which forces the shaped bodies onto a circular path. The shaped bodies can be subjected to this circumferential movement component for example by attaching suitably aligned guide rails to the side wall to deflect the catalyst supports. According to a further embodiment of the method according to the invention, however, it is provided that the gas and/or process gas fed into the process chamber is subjected to a circumferential flow component. The production of the catalyst support shaped body fluidized bed in which the catalyst support shaped bodies circulate toroidally is thereby made possible in a manner that is simple in terms of process engineering and thus inexpensive.

To subject the gas and/or process gas fed into the process chamber to the circumferential flow component, it can be provided according to an embodiment of the method according to the invention that suitably shaped and aligned gas guide elements are arranged between the annular guide plates. As an alternative or in addition to this, it can be provided that the gas and/or process gas fed into the process chamber is subjected to the circumferential flow component by feeding additional gas and/or process gas, with a movement component aligned diagonally upwards, into the process chamber through the bottom of the process chamber, for example in the area of the side wall of the process chamber.

It can be provided that the circulating catalyst support shaped bodies are sprayed with the solution by means of an annular gap nozzle which atomizes a spray cloud, wherein the spray cloud or its plane of symmetry can run substantially parallel to the plane of the device bottom. Due to the 360° circumference of the spray cloud, the shaped bodies can be sprayed particularly evenly with the solution. The annular gap nozzle, i.e. its mouth, is for example completely embedded in the shaped bodies.

According to an embodiment of the method according to the invention, it is provided that the annular gap nozzle is centrally arranged in the bottom and the mouth of the annular gap nozzle is completely embedded in the circulating catalyst supports. It is thereby made possible that the distance covered by the drops of the spray cloud until they meet a circulating shaped body is relatively short and, accordingly, relatively little time remains for the drops to coalesce into larger drops, which could work against the formation of a largely uniform shell thickness.

According to an embodiment of the method according to the invention with circulation of the shaped bodies, it can be provided that a gas support cushion is produced on the underside of the spray cloud. The bottom cushion keeps the bottom surface largely free of sprayed solution, for which reason almost all of the sprayed solution is introduced into the circulating shaped bodies, with the result that hardly any spray losses occur, which is important on cost grounds, in particular in respect of expensive noble-metal precursor compounds.

According to a further embodiment of the method according to the invention, it is provided that the catalyst support is formed spherical. A uniform rotation of the support about its axis and concomitantly a uniform impregnation of the catalyst support with the solution of the catalytically active species are thereby made possible during the circulation.

In embodiments of the method according to the invention, porous shaped bodies of any shape can be used as catalyst supports, wherein the supports can be formed from any support materials or material mixtures. In an embodiment, catalyst supports are used which comprise at least one metal oxide or are formed from a metal oxide or a metal oxide mixture. For example, the catalyst support comprises a silicon oxide, a silicon carbide, an aluminium oxide, an aluminosilicate, a zirconium oxide, a titanium oxide, a niobium oxide or a natural sheet silicate, or a calcined acid-treated bentonite.

By “natural sheet silicate”, for which the term “phyllosilicate” is also used in the literature, is meant untreated or treated silicate mineral from natural sources in which SiO₄ tetrahedra, which form the structural base unit of all silicates, are cross-linked with each other in layers of the general formula [Si₂O₅]²⁻. These tetrahedron layers alternate with so-called octahedron layers in which a cation, principally Al and Mg, is octahedrally surrounded by OH or O. A distinction is drawn for example between two-layer phyllosilicates and three-layer phyllosilicates. Sheet silicates used within the framework of the embodiments described here are for example clay minerals, in particular kaolinite, beidellite, hectorite, saponite, nontronite, mica, vermiculite and smectites, wherein smectites and in particular montmorillonite are particularly suitable. Definitions of the term “sheet silicates” are to be found for example in “Lehrbuch der anorganischen Chemie”, Hollemann Wiberg, de Gruyter, 102^{nd} edition, 2007 (ISBN 978-3-11-017770-1) or in “Römpp Lexikon Chemie”, 10^{th} edition, Georg Thieme Verlag under the heading “Phyllosilikat”. Typical treatments to which a natural sheet silicate is subjected before use as support material include for example a treatment with acids and/or calcining. A particularly suitable natural sheet silicate is a bentonite. Admittedly, bentonites are not really natural sheet silicates, but rather a mixture of predominantly clay minerals containing sheet silicates. Thus in the present case, where the natural sheet silicate is a bentonite, it is to be understood that the natural sheet silicate is present in the catalyst support in the form of or as a constituent of a bentonite.

Acid-treated bentonites can be obtained by treating bentonites with strong acids such as for example sulphuric acid, phosphoric acid or hydrochloric acid. A definition, also valid within the framework of the present invention, of the term bentonite is given in Römpp, Lexikon Chemie, 10^{th} edition, Georg Thieme Verlag. Bentonites used within the framework of embodiments described here are natural aluminium-containing sheet silicates which contain montmorillonite (as smectite) as main mineral. After the acid treatment, the bentonite is as a rule washed with water, dried and ground to a powder.

It was found that relatively large shell thicknesses of the catalyst can also be achieved by means of the method according to the invention. In fact, the smaller the surface area of the support, the greater the achievable thickness of the shell. According to an embodiment, the catalyst support can have a surface area of less than/equal to 160 m²/g, preferably less than 140 m²/g, by preference less than 135 m²/g, further preferably less than 120 m²/g, more preferably less than 100 m²/g, still more preferably less than 80 m²/g and particularly preferably less than 65 m²/g. By “surface area” of the catalyst support is meant within the framework of the present invention the BET surface area of the support which is determined by means of adsorption of nitrogen according to DIN 66132.

Within the framework of embodiments of the method according to the invention, the catalyst supports are subjected to a mechanical load stress during the circulation of the supports, which can result in a degree of wear as well as a degree of damage to catalyst supports, in particular in the area of the resulting shell. In particular to reduce the wear of the catalyst support, according to an embodiment the catalyst support has a hardness greater than/equal to 20 N, preferably greater than/equal to 30 N, further preferably greater than/equal to 40 N and most preferably greater than/equal to 50 N. The hardness is ascertained by means of an 8M tablet-hardness testing machine from Dr. Schleuniger Pharmatron AG, determining the average for 99 shaped bodies after drying at 130° C. for 2 h, wherein the apparatus settings are as follows:
Hardness: N
Distance from the shaped body: 5.00 mm
Time delay: 0.80 s
Feed type: 6 D
Speed: 0.60 mm/s

The hardness of the catalyst support can be influenced for example by varying certain parameters of the method for its production, for example through the selection of the support material, the calcining duration and/or the calcining temperature of an uncured shaped body formed from a corresponding support mixture, or by particular loading materials, such as for example methyl cellulose or magnesium stearate.

According to a further embodiment of the method according to the invention, the gas or the process gas used for the circulation can be recycled into the device by means of a closed loop, above all in the case of expensive gases such as e.g. helium, argon, etc.

According to an embodiment of the method according to the invention, the catalyst support is heated prior to and/or during the application of the transition-metal precursor compound. This can be achieved for example by means of the gas or process gas which is used for the circulation and was heated beforehand. The drying-off speed of the deposited solution of the transition-metal precursor compound can be determined via the degree of heating of the catalyst supports. At relatively low temperatures the drying-off speed is for example relatively low, with the result that with a corresponding quantitative deposition, greater shell thicknesses can be formed because of the high diffusion of the metal compound that is caused by the presence of solvent. At relatively high temperatures the drying-off speed is for example relatively high, with the result that solution coming into contact with the catalyst support almost immediately dries off, which is why solution deposited on the catalyst support cannot penetrate deep into the latter. At relatively high temperatures shells with relatively small thicknesses and a high metal loading can thus be obtained.

The thickness of the shell of the shell catalyst resulting from the method according to the invention can thus be influenced by the temperature at which the method according to the invention is carried out. In fact, thinner shells are normally obtained when the method is carried out at higher temperatures, whereas thicker shells are normally obtained at lower temperatures. According to an embodiment, e.g. in which the process gas already comes into contact with the shaped bodies during the application of the transition-metal precursor compound, it is therefore provided that the gas or process gas is heated, e.g. before being fed into the device in which the method according to the invention is carried out. For example, the process gas can be heated to a temperature between 80 and 200° C. or already to the temperature used during the reduction of the metal component of the precursor compound.

To prevent drops of the spray cloud from drying prematurely, it can be provided according to an embodiment of the method according to the invention that the process gas is enriched for application of the transition-metal precursor compound, before being fed into the device, with the solvent of the solution of the transition-metal precursor compound sprayed into the device, preferably in a range of from 10 to 50% of the saturation vapour pressure (at process temperature).

Solutions of metal compounds of any transition metals can be used in embodiments of the method according to the invention. The solution of the transition-metal precursor compound can contain a noble-metal compound as transition-metal precursor compound.

According to an embodiment of the method according to the invention, it is provided that the noble-metal compound is selected from the halides, in particular chlorides, oxides, nitrates, nitrites, formates, propionates, oxalates, acetates, citrates, tartrates, lactates, hydroxides, hydrogen carbonates, hydrogen phosphates, sulphites, amine complexes or organic complexes, for example triphenylphosphine complexes or acetylacetonate complexes, as well as alkali metallates, of the noble metals. In an embodiment, the transition-metal precursor compound or the noble-metal compound is chloride-free.

To produce a shell catalyst for oxidation reactions, it is provided according to an embodiment of the method according to the invention that the solution of the transition-metal precursor compound contains a Pd compound as transition-metal precursor compound.

Furthermore, to produce a shell catalyst according to embodiments of the method according to the invention, it is provided that the solution of the transition-metal precursor compound contains, as transition-metal precursor compound, at least one compound selected from: a Pd compound, an Au compound, a Pt compound, an Ag compound, an Ni compound, a Co compound and a Cu compound.

In methods described in the state of the art for producing VAM shell catalysts based on Pd and Au, commercially available solutions of the precursor compounds such as Na₂PdCl₄, NaAuCl₄ or HAuCl₄ solutions are customarily used. In the more recent literature, chloride-free Pd or Au precursor compounds such as for example Pd(NH₃)₄(OH)₂, Pd(NH₃)₂(NO₂)₂ and KAuO₂ are also used. These precursor compounds react base in solution, while the standard chloride, nitrate and acetate precursor compounds all react acid in solution.

In principle, any Pd or Au compound by means of which a high degree of dispersion of the metal particles desired for VAM synthesis can be achieved can be used as Pd and Au precursor compound. By “degree of dispersion” is meant the ratio of the number of all the surface metal atoms (of the metal concerned) of all the metal/alloy particles of a supported metal catalyst to the total number of all the metal atoms of the metal/alloy particles. The degree of dispersion can correspond to a relatively high numerical value, since in this case as many metal atoms as possible are freely accessible for a catalytic reaction. This means that, given a relatively high degree of dispersion of a supported metal catalyst, a specific catalytic activity of same can be achieved with a relatively small quantity of metal used.

Examples of Pd precursor compounds are water-soluble Pd salts. According to an embodiment of the method according to the invention, the Pd precursor compound is selected from the group consisting of H₂PdCl₄, K₂PdCl₄, (NH₄)₂PdCl₄, Pd(NH₃)₄Cl₂, Pd (NH₃)₄(HCO₃)₂, Pd(NH₃)₄(HPO₄), ammonium Pd oxalate, Pd oxalate, K₂Pd(oxalate)₂, Pd(II) trifluoroacetate, Pd(NH₃)₄(OH)₂, Pd(NO₃)₂, K₂Pd(OAc)₂(OH)₂, Pd(NH₃)₂(NO₂)₂, Pd(NH₃)₄(NO₃)₂, K₂Pd (NO₂)₄, Na₂Pd(NO₂)₄, Pd (OAc)₂, PdCl₂ and Na₂PdCl₄. In addition to Pd(OAc)₂ other carboxylates of palladium can also be used, preferably the salts of the aliphatic monocarboxylic acids with 3 to 5 carbon atoms, for example the propionate or butyrate salt.

Examples of Au precursor compounds are water-soluble Au salts. According to an embodiment of the method according to the invention, the Au precursor compound is selected from the group consisting of KAuO₂, NaAuO₂, KAuCl₄, (NH₄)AuCl₄, NaAu(OAc)₃(OH), HAuCl₄, KAu(NO₂)₄, AuCl₃, NaAuCl₄, KAu(OAc)₃(OH), HAu(NO₃)₄ and Au(OAc)₃. It is recommended where appropriate to produce fresh Au(OAc)₃ or KAuO₂ each time by precipitating the oxide/hydroxide from a gold acid solution, washing and isolating the precipitate as well as taking up same in acetic acid or KOH.

Examples of Pt precursor compounds are water-soluble Pt salts. According to an embodiment of the method according to the invention, the Pt precursor compound is selected from the group consisting of Pt(NH₃)₄(OH)₂, Pt(NO₃)₂, K₂Pt(OAC)₂(OH)₂, Pt(NH₃)₂(NO₂)₂, PtCl₄, H₂Pt(OH)₆, Na₂Pt(OH)₆, K₂Pt(OH)₆, K₂Pt(NO₂)₄, Na₂Pt(NO₂)₄, Pt(OAC)₂, PtCl₂, K₂PtCl₄, H₂PtCl₆, (NH₄)₂PtCl₄, (NH₃)₄PtCl₂, Pt(NH₃)₄(HCO₃)₂, Pt(NH₃)₄(HPO₄), Pt(NH₃)₄(NO₃)₂ and Na₂PtCl₄. In addition to Pt(OAc)₂ other carboxylates of platinum can also be used, preferably the salts of the aliphatic monocarboxylic acids with 3 to 5 carbon atoms, for example the propionate or butyrate salt. Instead of NH₃ it is also possible to use the corresponding complex salts with ethylenediamine or ethanolamine as ligand.

Examples of Ag precursor compounds are water-soluble Ag salts. According to an embodiment of the method according to the invention, the Ag precursor compound is selected from the group consisting of Ag(NH₃)₂(OH)₂, Ag(NO₃), K₂Ag(OAc) (OH)₂, Ag(NH₃)₂(NO₂), Ag(NO₂), Ag lactate, Ag trifluoroacetate, Ag salicylate, K₂Ag(NO₂)₃, Na₂Ag(NO₂)₃, Ag(OAc), ammoniacal AgCl₂ solution, ammoniacal Ag₂CO₃ solution, ammoniacal AgO solution and Na₂AgCl₃. In addition to Ag(OAc) other carboxylates of silver can also be used, preferably the salts of the aliphatic monocarboxylic acids with 3 to 5 carbon atoms, for example the propionate or butyrate salt.

According to embodiments of the method according to the invention, transition-metal nitrite precursor compounds can also be used. Ag nitrite precursor compounds are for example those which are obtained by dissolving Ag(OAc) in an Na—NO₂ solution. Pd nitrite precursor compounds are for example those which are obtained by dissolving Pd(OAc)₂ in an NaNO₂ or KNO₂ solution. Pt nitrite precursor compounds are for example those which are obtained by dissolving Pt(OAc)₂ in an NaNO₂ solution.

Pure solvents and solvent mixtures in which the selected metal compound is soluble and which, after deposition onto the catalyst support, can be easily removed again from same by means of drying are particularly suitable as solvents for the transition-metal precursor compound. Solvent examples for metal acetates as precursor compounds are above all unsubstituted carboxylic acids, in particular acetic acid, ketones such as acetone, and for the metal chlorides above all water or dilute hydrochloric acid.

If the precursor compound is not sufficiently soluble in acetic acid, water or dilute hydrochloric acid or mixtures thereof, other solvents can also be used as an alternative or in addition to the named solvents. Solvents which are inert come into consideration as other solvents in this case. Ketones, for example acetone or acetylacetone, furthermore ethers, for example tetrahydrofuran or dioxan, acetonitrile, dimethylformamide and solvents based on hydrocarbons such as for example benzene may be named as solvents which are suitable for adding to acetic acid.

Ketones, for example acetone, or alcohols, for example ethanol or isopropanol or methoxyethanol, lyes, such as aqueous KOH or NaOH, or organic acids, such as acetic acid, formic acid, citric acid, tartaric acid, malic acid, glyoxylic acid, glycolic acid, oxalic acid, pyruvic acid or lactic acid may be named as examples of a solvent or additive which are suitable for adding to water. Within the framework of embodiments of the method according to the invention, the solvent used in the process can be recovered, for example by means of suitable cooling aggregates, condensers and separators.

One embodiment provides a shell catalyst that can be or is obtained by a method according to one of the embodiments of the method described here. By embodiments of the method in which a circulation of the shaped bodies during the application of the transition-metal precursor compound takes place, a shell catalyst can be obtained which comprises a porous catalyst support shaped body with an outer shell in which at least one transition metal in particulate metal form is contained, wherein the proportion by mass of the transition metal in the catalyst is more than 0.3 mass-%, preferably more than 0.5 mass-% and by preference more than 0.8 mass-%, and the average dispersion of the transition-metal particles is greater than 20%, preferably greater than 23%, by preference greater than 25% and more preferably greater than 27%. By embodiments without circulation of the shaped bodies during the application of the transition-metal precursor compound, a shell catalyst can be obtained, with 0.3 to 4, preferably 0.5 to 3 mass-% transition metal, in each case relative to the weight of the support used.

Transition-metal shell catalysts with such high metal loadings with a simultaneously high metal dispersion can be obtained by means of embodiments of the method according to the invention. The transition-metal dispersion is determined by means of the DIN standard for the respective metal. On the other hand, the dispersion of the noble metals Pt, Pd and Rh is determined by means of CO chemisorption according to “Journal of Catalysis 120, 370-376 (1989)”. The dispersion of Cu is determined by means of N₂O. According to an embodiment of the shell catalyst according to the invention, produced with embodiments of the method in which a circulation of the shaped bodies takes place during the application of the transition-metal precursor compound, the concentration of the transition metal can vary, over an area of 90% of the shell thickness, the area being at a distance of 5% of the shell thickness from each of the outer and inner shell limit, from the average concentration of transition metal of this area by a maximum of +/−200, preferably by a maximum of +/−15% and by preference by a maximum of +/−10%. Due to a largely uniform distribution of the transition metal within the shell, a largely uniform activity of embodiments of the catalyst according to the invention over the thickness of the shell is made possible, as the concentration of transition metal varies only relatively little over the shell thickness. In other words, the profile of the concentration of transition metal describes an approximately rectangular function over the shell thickness.

To further increase the selectivity of embodiments of the catalyst according to the invention, it can be provided that, seen over the thickness of the shell of the catalyst, the maximum concentration of transition metal is in the area of the outer shell limit and the concentration decreases towards the inner shell limit. The concentration of transition metal can decrease constantly towards the inner shell limit over an area of at least 25% of the shell thickness, preferably over an area of at least 40% of the shell thickness and by preference over an area of from 30 to 80% of the shell thickness.

According to an embodiment of the catalyst according to the invention, the concentration of transition metal decreases roughly constantly towards the inner shell limit to a concentration of from 50 to 90% of the maximum concentration, preferably to a concentration of from 70 to 90% of the maximum concentration. In embodiments described here, the transition metal is selected from the group of the noble metals.

In embodiments described here, the catalyst can contain two or more different metals in metal form in the shell, wherein the two metals are combinations of one of the following pairs: Pd and Ag; Pd and Au; Pd and Pt. Catalysts with a Pd/Au shell are suitable in particular for producing VAM, those with a Pd/Pt shell are suitable in particular as oxidation and hydrogenation catalysts and those with a Pd/Ag shell are suitable in particular for the selective hydrogenation of alkynes and dienes in olefin streams, thus for example for producing purified ethylene by selective hydrogenation of acetylene contained in the untreated product.

To provide a VAM shell catalyst with a particularly suitable VAM activity, the catalyst can contain Pd and Au as noble metals and the proportion of Pd in the catalyst can be 0.6 to 2.5 mass-%, preferably 0.7 to 2.3 mass-% and by preference 0.8 to 2 mass-%, relative to the mass of the catalyst support loaded with noble metal.

In addition, in the above connection the Au/Pd atomic ratio of the catalyst can be between 0 and 1.2, preferably between 0.1 and 1, by preference between 0.2 and 0.9 and particularly preferably between 0.3 and 0.8.

To produce a Pd/Au shell catalyst, at least one alkali metal compound, preferably a potassium, sodium, caesium or rubidium compound, by preference a potassium compound, can be used as promoter. Suitable potassium compounds include potassium acetate KOAc, potassium carbonate K₂CO₃, potassium hydrogen carbonate KHCO₃ and potassium hydroxide KOH as well as all potassium compounds which become K-acetate KOAc under the respective reaction conditions of VAM synthesis. The potassium compound can be deposited onto the catalyst support both before and after the reduction of the metal components into the metals Pd and Au. According to an embodiment of the catalyst according to the invention, the catalyst comprises an alkali metal acetate, preferably potassium acetate. It is particularly beneficial in order to achieve a desired promoter activity if the alkali metal acetate content of the catalyst is 0.1 to 0.7 mol/l, preferably 0.3 to 0.5 mol/l.

According to a further embodiment of a Pd/Au catalyst according to the invention, the alkali metal/Pd atomic ratio is between 1 and 12, preferably between 2 and 10 and particularly preferably between 4 and 9. The smaller the surface area of the catalyst support is, the lower the alkali metal/Pd atomic ratio can be.

It has been established that, the smaller the surface area of the catalyst support, the higher the product selectivities of a Pd/Au catalyst according to the invention. In addition, the smaller the surface area of the catalyst support is, the greater the chosen thickness of the metal shell can be, without appreciable losses of product selectivity having to be accepted. According to an embodiment, the surface of the catalyst support therefore has a surface area of less than/equal to 160 m²/g, preferably less than 140 m²/g, by preference less than 135 m²/g, further preferably less than 120 m²/g, more preferably less than 100 m²/g, still more preferably less than 80 m²/g and particularly preferably less than 65 m²/g. In an embodiment, the catalyst support can have a bulk density of more than 0.3 g/ml, preferably more than 0.35 g/ml and particularly preferably a bulk density of between 0.35 and 0.6 g/ml.

In view of a small pore diffusion limitation, it can be provided according to an embodiment that the catalyst support has an average pore diameter of from 8 to 50 nm, preferably 10 to 35 nm and by preference 11 to 30 nm.

The acidity of the catalyst support can advantageously influence the activity of the catalyst according to the invention. According to an embodiment the catalyst support has an acidity of between 1 and 150 μval/g, preferably between 5 and 130 μval/g and particularly preferably between 10 and 100 μval/g. The acidity of the catalyst support is determined as follows: 100 ml water (with a pH blank value) is added to 1 g of the finely ground catalyst support and extraction carried out for 15 minutes accompanied by stirring. Titration to at least pH 7.0 with 0.01 n NaOH solution follows, wherein the titration is carried out stepwise; 1 ml of the NaOH solution is firstly added dropwise to the extract (1 drop/second), followed by a 2-minute wait, the pH is read, a further 1 ml NaOH added dropwise, etc. The blank value of the water used is determined and the acidity calculation corrected accordingly.

The titration curve (ml 0.01 NaOH against pH) is then plotted and the intersection point of the titration curve at pH 7 determined. The mole equivalents which result from the NaOH consumption for the intersection point at pH 7 are calculated in 10⁻⁶ equiv/g support.

$$\frac{10 * ml 0.01 n NaOH}{1 support} = μval \text{/} g$$

### Total Acid:

To increase the activity of a Pd/Au catalyst according to the invention, it can be provided that the catalyst support is doped with at least one oxide of a metal selected from the group consisting of Zr, Hf, Ti, Nb, Ta, W, Mg, Re, Y and Fe, for example with ZrO₂, HfO₂ or Fe₂O₃. The proportion of doping oxide in the catalyst support can be between 0 and 25 mass-%, preferably 1.0 and 20 mass-% and by preference 3 and 15 mass-%, relative to the mass of the catalyst support.

According to an alternative embodiment of the catalyst according to the invention, it contains Pd and Ag as noble metals and, to provide a particularly desired activity of the catalyst, preferably in the hydrogenation of acetylene, the proportion of Pd in the catalyst is 0.01 to 1.0 mass-%, preferably 0.015 to 0.8 mass-% and by preference 0.02 to 0.7 mass-%, relative to the mass of the catalyst support loaded with noble metal. Typical Pd loadings for the selective hydrogenation are 100 to 250 ppm Pd.

Likewise to achieve a particularly desired activity of the catalyst in the hydrogenation of acetylene, the Ag/Pd atomic ratio of the catalyst is between 0 and 10, preferably between 1 and 5, wherein it is preferred that the thickness of the noble-metal shell is smaller than 60 μm.

According to an embodiment, the catalyst support is formed as a sphere with a diameter greater than 1.5 mm, preferably with a diameter greater than 3 mm and by preference with a diameter of from 4 to 9 mm or 2 to 4 mm, or as a cylindrical tablet with dimensions of up to 7×7 mm.

According to an embodiment, the catalyst support has a surface area of from 1 to 50 m²/g, preferably between 3 and 20 m²/g. Furthermore it can be preferred that the catalyst support has a surface area less than/equal to 10 m²/g, preferably less than 5 m²/g and by preference less than 2 m²/g. For example, the surface area of the catalyst support preferred for a “front-end” selective hydrogenation is approximately 5 m²/g. In another example, the surface area of the catalyst support preferred for a “tail-end” selective hydrogenation is 60 m²/g. These values apply e.g. to 4.5×4.5 mm alumina tablets.

An oxidation or hydrogenation catalyst according to the invention can contain Pd and Pt as noble metals, wherein the proportion of Pd in the catalyst is 0.05 to 5 mass-%, preferably 0.1 to 2.5 mass-% and by preference 0.15 to 0.9 mass-%, relative to the mass of the catalyst support loaded with noble metal.

According to an embodiment of a Pd/Pt catalyst according to the invention, the Pd/Pt atomic ratio of the catalyst is between 10 and 1, preferably between 8 and 5 and by preference between 7 and 4. Typically, the catalyst can be loaded with 0.45% Pd and 0.15% Pt, thus have a Pd/Pt ratio of 5.5.

According to an embodiment, the catalyst support is formed as a cylinder, preferably with a diameter of from 0.75 to 3 mm and with a length of from 0.3 to 7 mm, or as a sphere with a diameter of from 2 to 7 mm.

It can furthermore be that the catalyst support has a surface area of from 50 to 400 m²/g, preferably between 100 and 300 m²/g.

The catalyst can also contain metallic Co, Ni and/or Cu as transition metal in the shell.

According to a further embodiment, it is provided that the catalyst support is a support based on a silicon oxide, an aluminium oxide, an aluminosilicate, a zirconium oxide, a titanium oxide, a niobium oxide or a natural sheet silicate, preferably a calcined acid-treated bentonite. The expression “based on” means that the catalyst support comprises one or more of the named materials.

As already stated above, the catalyst support of the catalyst according to the invention is subjected to a degree of mechanical stress during production of the catalyst. In addition, the catalyst according to the invention can be subjected to a strong mechanical load stress during the filling of a reactor, which can result in an undesired formation of dust as well as damage to the catalyst support, in particular to its catalytically active shell lying in an outer area. In particular to keep the wear of the catalyst according to the invention within reasonable limits, the catalyst support has a hardness greater than/equal to 20 N, preferably greater than/equal to 30 N, further preferably greater than/equal to 40 N and most preferably greater than/equal to 50 N. The indentation hardness is determined as described above.

Embodiments described here can comprise as catalyst support a catalyst support based on a natural sheet silicate, in particular an acid-treated calcined bentonite. The expression “based on” means that the catalyst support comprises the corresponding metal oxide. In embodiments, the proportion of natural sheet silicate, in particular acid-treated calcined bentonite, in the catalyst support can be greater than/equal to 50 mass-%, preferably greater than/equal to 60 mass-%, by preference greater than/equal to 70 mass-%, further preferably greater than/equal to 80 mass-%, more preferably greater than/equal to 90 mass-% and most preferably greater than/equal to 95 mass-%, relative to the mass of the catalyst support.

It was found that the product selectivity in particular of a Pd/Au catalyst according to the invention is higher the larger the integral pore volume of the catalyst support. According to an embodiment, the catalyst support therefore has an integral pore volume according to BJH of more than 0.30 ml/g, preferably more than 0.35 ml/g, and by preference more than 0.40 ml/g.

Furthermore, in particular in respect of the Pd/Au catalyst, the catalyst support can have an integral BJH pore volume of between 0.25 and 0.7 ml/g, preferably between 0.3 and 0.6 ml/g and by preference from 0.35 to 0.5 ml/g.

The integral pore volume of the catalyst support is determined according to the BJH method by means of nitrogen adsorption. The surface area of the catalyst support as well as its integral pore volume are determined according to the BET or according to the BJH method. The BET surface area is determined according to the BET method according to DIN 66131; a publication of the BET method is also found in J. Am. Chem. Soc. 60, 309 (1938). In order to determine the surface area and the integral pore volume of the catalyst support or the catalyst, the sample can be measured for example with a fully automatic nitrogen porosimeter from Micromeritics, type ASAP 2010, by means of which an adsorption as well as desorption isotherm is recorded.

To determine the surface area and the porosity of the catalyst support or catalyst according to the BET theory, the data are evaluated according to DIN 66131. The pore volume is determined from the measurement data using the BJH method (E. P. Barrett, L. G. Joyner, P. P. Halenda, J. Am. Chem. Soc. (73/1951, 373)). Effects of capillary condensation are also taken into account when using this method. Pore volumes of specific pore size ranges are determined by totaling incremental pore volumes which are obtained from the evaluation of the adsorption isotherms according to BJH. The integral pore volume according to the BJH method relates to pores with a diameter of from 1.7 to 300 nm.

It can be provided according to an embodiment that the water absorbency of the catalyst support is 40 to 75%, preferably 50 to 70% calculated as the weight increase due to water absorption. The absorbency is determined by steeping 10 g of the support sample in deionized water for 30 min until gas bubbles no longer escape from the support sample. The excess water is then decanted and the steeped sample blotted with a cotton towel to remove adhering moisture from the sample. The water-laden support is then weighed out and the absorbency calculated as follows:

(amount weighed out(g)−amount weighed in(g))×10=water absorbency(%)

According to a further embodiment, in particular of the Pd/Au catalyst, at least 80%, preferably at least 85% and by preference at least 90%, of the integral pore volume of the catalyst support can be formed from mesopores and macropores. This counteracts a reduced activity, effected by diffusion limitation, of the catalyst according to the invention, in particular with relatively thick shells. By micropores, mesopores and macropores are meant in this case pores which have a diameter of less than 2 nm, a diameter of from 2 to 50 nm and a diameter of more than 50 nm respectively.

The catalyst support according to embodiments described here is formed as a shaped body. The catalyst support can in principle assume the form of any geometric body to which a corresponding shell can be applied. For example, the catalyst support can be formed as a sphere, cylinder (also with rounded end surfaces), perforated cylinder (also with rounded end surfaces), trilobe, “capped tablet”, tetralobe, ring, doughnut, star, cartwheel, “reverse” cartwheel, or as a strand, preferably as a ribbed strand or star strand.

The diameter or the length and thickness of the catalyst support according to embodiments is for example 2 to 9 mm, depending on the geometry of the reactor tube in which the catalyst is to be used.

Typically, the smaller the thickness of the shell of the catalyst, the higher the product selectivity of the catalyst according to the invention. According to an embodiment of the catalyst according to the invention, the shell of the catalyst therefore has a thickness of less than 400 μm, preferably less than 300 μm, by preference less than 250 μm, further preferably less than 200 μm and more preferably less than 150 μm. For example, in the case of shell catalysts for producing vinyl acetate monomer (VAM), a particularly suitable shell thickness is approximately 200 μm.

As a rule in the case of supported metal catalysts, the thickness of the shell can be measured visually by means of a microscope. The area in which the metals are deposited appears black, while the areas free of metals appear white. As a rule, the boundary between areas containing metals and areas free of them is very sharp and can clearly be recognized visually. If the above-named boundary is not sharply defined and accordingly not clearly recognizable visually or the shell thickness cannot be determined visually for other reasons, the thickness of the shell corresponds to the thickness of a shell, measured starting from the outer surface of the catalyst support, which contains 95% of the transition metal deposited on the support.

It was likewise found that in the case of the catalyst according to the invention the shell can be formed with a relatively large thickness effecting a high activity of the catalyst, without effecting an appreciable reduction of the product selectivity of the catalyst according to the invention. Catalyst supports with a relatively small surface area can be used for this. According to another embodiment of the catalyst according to the invention, the shell of the catalyst therefore has a thickness of between 200 and 2000 μm, preferably between 250 and 1800 μm, by preference between 300 and 1500 μm and further preferably between 400 and 1200 μm.

An embodiment furthermore provides the use of a device which is setup to cause a circulation of the catalyst support shaped bodies by means of a gas and/or process gas, preferably a fluid bed or a fluidized bed, preferably a fluidized bed, in which the catalyst support shaped bodies circulate elliptically or toroidally, preferably toroidally, for carrying out an embodiment of the method according to the invention or in the production of a shell catalyst, in particular a shell catalyst according to the invention. It has been established that shell catalysts which display the above-named advantageous properties can be produced by means of such devices.

According to an embodiment, it is provided that the device comprises a process chamber with a bottom and a side wall, wherein the bottom is constructed of several overlapping annular guide plates laid one over another between which annular slots are formed via which gas and/or process gas can be fed in with a substantially horizontal movement component aligned radially outwards. The formation of a fluidized bed is thereby made possible in a way that is simple in terms of process engineering in which the shaped bodies circulate elliptically or toroidally in a particularly uniform manner, which is accompanied by an increase in product quality.

In order to make possible a particularly uniform spraying of the shaped bodies, for example with noble metal solutions, it can be provided according to a further embodiment that in the device an annular gap nozzle is centrally arranged, in the bottom, the mouth of which is formed such that a spray cloud, the mirror plane of which runs substantially parallel to the bottom plane, can be sprayed with the nozzle.

Furthermore, outlets for support gas can be provided between the mouth of the annular gap nozzle and the bottom lying beneath it, in order to produce a support cushion on the underside of the spray cloud. The bottom air cushion keeps the bottom surface free of sprayed solution, which means that all of the sprayed solution is introduced into the fluidized bed of the shaped bodies, with the result that no spray losses occur, which is important in particular in respect of expensive noble-metal compounds.

According to a further embodiment of the use according to the invention of the device, the support gas in the device is provided by the annular gap nozzle itself and/or by process gas. These measures allow the support gas to be produced in a wide variety of ways. At the annular gap nozzle itself outlets can be provided via which some of the spray gas emerges in order to contribute to the formation of the support gas. In addition or alternatively, some of the process gas which flows through the bottom can be guided towards the underside of the spray cloud and thereby contribute to the formation of the support gas.

According to a further embodiment, the annular gap nozzle has an approximately conical head and the mouth runs along a circular conical section surface. It is thereby made possible that the shaped bodies moving vertically downwards are led uniformly and in a targeted manner through the cone to the spray cloud which is sprayed by the circular spray gap in the lower end of the cone.

According to a further embodiment of the use of the device, there is provided in the area between mouth and bottom lying beneath it a truncated-cone-shaped wall which for example has passage openings for support gas. This measure has the advantage that the previously mentioned harmonic deflection movement at the cone is maintained by the continuation over the truncated cone and in this area support gas can emerge through the passage openings and provide the corresponding support on the underside of the spray cloud.

In a further version of the use of the device, an annular slot for the passage of gas and/or process gas is formed between the underside of the truncated-cone-shaped wall. This measure has the advantage that the transfer of the shaped bodies onto the air cushion of the bottom can be particularly well controlled and can be carried out in a targeted manner beginning in the area immediately underneath the nozzle.

In order to be able to introduce the spray cloud into the fluidized bed at the desired height, the position of the mouth of the nozzle can be height-adjustable.

According to a further version of the use according to the invention of the device, guide elements which impose an extensive flow component on the process gas passing through are arranged between the annular guide plates.

The following description of an embodiment of a device for carrying out an embodiment of the method according to the invention serves to explain the invention with the help of figures. There are shown in:

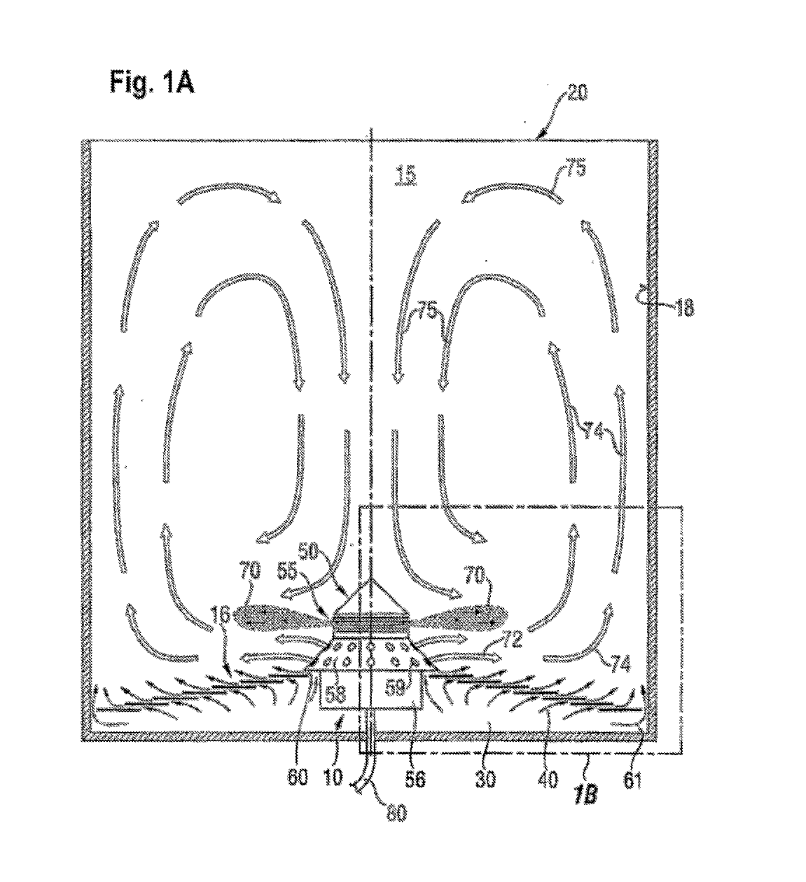

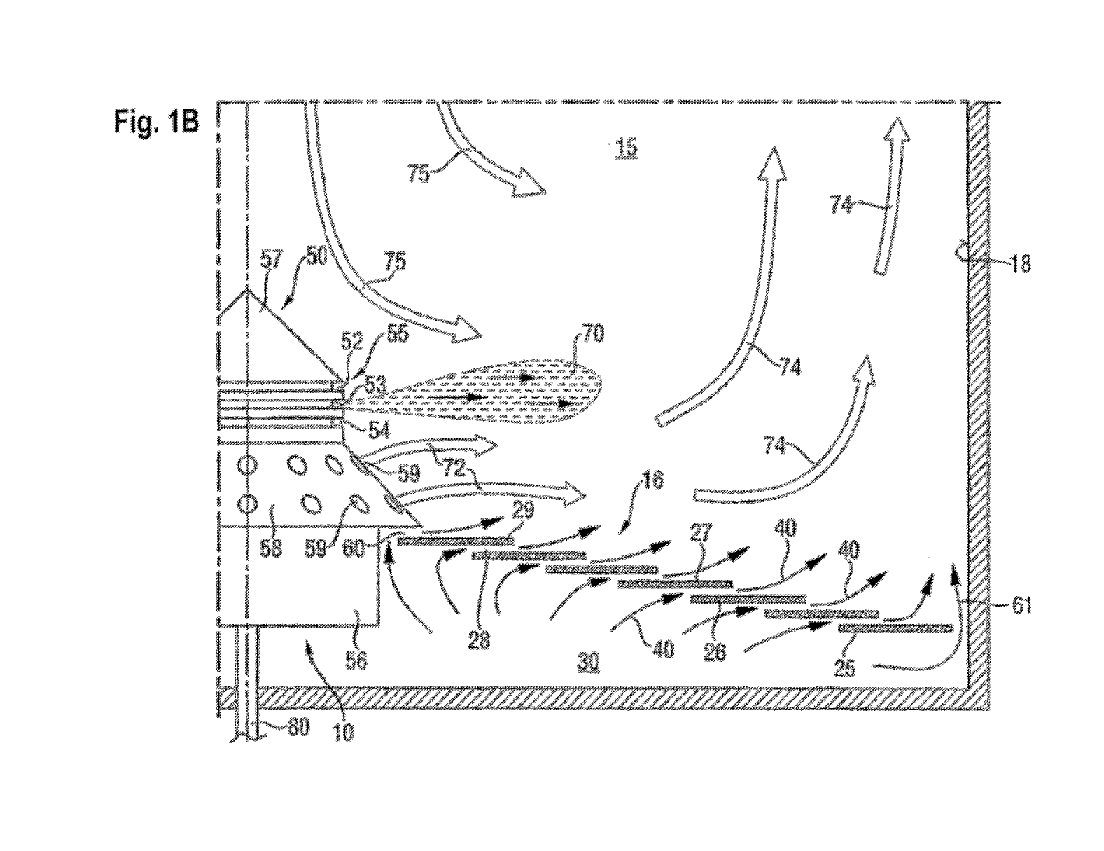

FIG. 1A a vertical sectional view of a device for carrying out an embodiment of the method according to the invention, in which a circulation of the catalyst support shaped bodies in the process gas takes place during the application of the transition-metal precursor compound and during the conversion of the metal component of the transition-metal precursor compound into the metal form; and

FIG. 1B an enlargement of the framed area in FIG. 1A numbered 1B.

A device, numbered 10 as a whole, for carrying out an embodiment of the method according to the invention, which comprises a circulation of the catalyst support shaped bodies, is shown in FIG. 1A.

The device 10 has a container 20 with an upright cylindrical side wall 18 which encircles a process chamber 15.

The process chamber 15 has a bottom 16 below which is a blowing chamber 30.

The bottom 16 consists of a total of seven annular plates, laid one over another, as guide plates. The seven annular plates are positioned one over another in such a way that an outermost annular plate 25 forms an undermost annular plate on which the other six inner annular plates, each one partially overlapping the one beneath it, are then placed. For the sake of clarity, only some of the total of seven annular plates have reference numbers, for example the two overlapping annular plates 26 and 27. Due to this overlapping and spacing, an annular slot 28 is formed in each case between two annular plates, through which e.g. a nitrogen/hydrogen mixture or a nitrogen/ethylene mixture 40 can pass as the process gas, with a predominantly horizontally aligned movement component, through the bottom 16.

An annular gap nozzle 50 is inserted from below in the central opening of the central uppermost inner annular plate 29. The annular gap nozzle 50 has a mouth 55 which has a total of three orifice gaps 52, 53 and 54. All three orifice gaps 52, 53 and 54 are aligned so as to spray approximately parallel to the bottom 16, thus approximately horizontally, covering an angle of 360°. Spray gas is expressed via the upper gap 52 as well as the lower gap 54, the solution to be sprayed is expressed through the central gap 53.

The annular gap nozzle 50 has a rod-shaped body 56 which extends downwards and contains the corresponding channels and feed lines 80. The annular gap nozzle 50 can be formed for example with a so-called rotating annular gap, in which walls of the channel through which the solution is sprayed out rotate relative to each other, in order to avoid blockages of the nozzle, thus making possible a uniform spraying out from the gap 53 over the whole angle of 360°. The annular gap nozzle 50 has a conical head 57 above the orifice gap 52.

In the area below the orifice gap 54 is a truncated-cone-shaped wall 58 which has numerous apertures 59. As can be seen in particular from FIG. 1B, the underside of the truncated-cone-shaped wall 58 rests on the innermost annular plate 29 in such a way that a slot 60 is formed, through which process gas 40 can pass as support gas, between the underside of the truncated-cone-shaped wall 58 and the annular plate 29 lying below and partially overlapping it.

The outer ring 25 is at a distance from the wall 18, with the result that process gas 40 can enter the process chamber 15, with a predominantly vertical component, in the direction of the arrow given the reference number 61 and thereby gives the process gas 40 entering the process chamber 15 through the slot 28 a movement component aligned relatively sharply upwards.

FIG. 1A and sections of FIG. 1B show what relationships form in the device 10 after entry.

A spray cloud 70, the horizontal mirror plane of which runs approximately parallel to the bottom plane, emerges from the orifice gap 53. Support gas passing through the apertures 59 in the truncated-cone-shaped wall 58, which can be for example process gas, forms a supporting gas flow 72 on the underside of the spray cloud 70. A radial flow in the direction of the wall 18 by which the process gas 40 is deflected upwards, as represented by the arrow given the reference number 74, is formed by the process gas 40 passing through the numerous slots 28. The shaped bodies are guided upwards by the deflected process gas 40 in the area of the wall 18. The process gas 40 and the catalyst support shaped bodies to be treated then separate from each other, wherein the process gas 40 is discharged through outlets, while the shaped bodies move radially inwards as shown by the arrow 75 and travel approximately vertically downwards in the direction of the conical head 57 of the annular gap nozzle 50 as a result of gravity. The falling shaped bodies are deflected there, carried to the upperside of the spray cloud 70 and treated there with the sprayed medium. The sprayed shaped bodies then move again towards the wall 18 and away from each other, as a much larger space is available to the shaped bodies at the annular orifice gap 53 after leaving the spray cloud 70. In the area of the spray cloud 70, the shaped bodies to be treated encounter liquid particles and are moved in the direction of movement towards the wall 18, remaining apart from each other, and treated very uniformly and harmonically with the process gas 40 and also dried.

Elliptical or toroidally circulating movement paths of the shaped bodies can be realized with the device shown in FIGS. 1A and 1B. Corresponding methods, devices and catalysts produced with these are described in DE 102007025356 A1, the full disclosure of which is contained here by reference.

In another embodiment, instead of the centrally arranged concentric annular gap nozzle 50, the device can have a plurality of, e.g. two, circular-segment nozzles with which two fluidized beds circulating in opposite directions can be sprayed with the spray gas. This device comprises, in the bottom, two concentric multi-plate rings, each consisting of a plurality of circular plates arranged in steps above each other. The inner multi-plate ring, i.e. that provided in the centre of the container bottom, is arranged in such a way that the process gas flows into the container, outwardly towards the container wall, between the plates horizontally with a circumferential flow component. The outer multi-plate ring which concentrically surrounds the inner plate ring is arranged in such a way that the process gas flows into the container, inwardly towards the container centre, between the plates horizontally with a circumferential flow component. Converging air-glide layers, on which the catalyst support shaped bodies are transported in two fluidized beds circulating in opposite directions, can thereby form at the bottom of the container.

A circular flow safeguard is provided between the two multi-plate rings, concentric with the plates, in order to prevent the two fluidized beds from mixing and to deflect the fluidized beds perpendicularly upwards. The flow safeguard consists for example of two deflector plates each of which has a quadrant-shaped profile, i.e. a quadrant-shaped cross-section, wherein the quadrant has two ends. The deflector plates are each fastened, by one end of the quadrant, to the corresponding plates adjacent to the flow safeguard. The other ends of the quadrant-shaped deflector plates are arranged lying against each other and thus form an upwardly directed annular projection with a concave curvature on both sides. The converging gas streams emerging between the plates, as well as the shaped bodies transported therein, are carried in two toroidal flows by deflection at the annular projection.

Inside the annular projection, concentric circular-segment nozzles are arranged, i.e. individual segments of the annular projection are replaced by the circular-segment nozzles. The outer part of the circular-segment nozzles directed into the inside of the container has approximately the shape of the annular projection. The apertures of the circular-segment nozzles are provided in the shape of annular segments in the upwardly directed end of the circular-segment nozzles. If the catalyst shaped bodies are transported in the two fluidized beds circulating in opposite directions, they pass through the spray cloud of the circular-segment nozzles while they are being deflected perpendicularly upwards at the annular projection and at the circular-segment nozzles. After passing through the spray cloud, the shaped bodies are transported through the container by the toroidal gas streams deflected upwards at the annular projection in an approximately toroidal fluidized bed. The described process gas guiding provides the basis for a largely double homogeneous, toroidal fluidized-bed-like circulating movement of the catalyst supports. The structure of the device with two annular segment nozzles makes it possible to apply the transition-metal precursor compound in several different ways. For example, both nozzles can be simultaneously charged with a Pd—Au mixed solution, such as a mixture of solutions of Pd(NH₃)₄(OH)₂ and KAuO₂. Or the Pd and Au solutions are carried separately through the two nozzles.

All non-mutually exclusive features described here of embodiments can be combined with one another. The invention will now be described in more detail by the following examples with reference to further figures, without being regarded as limiting. There are shown in:

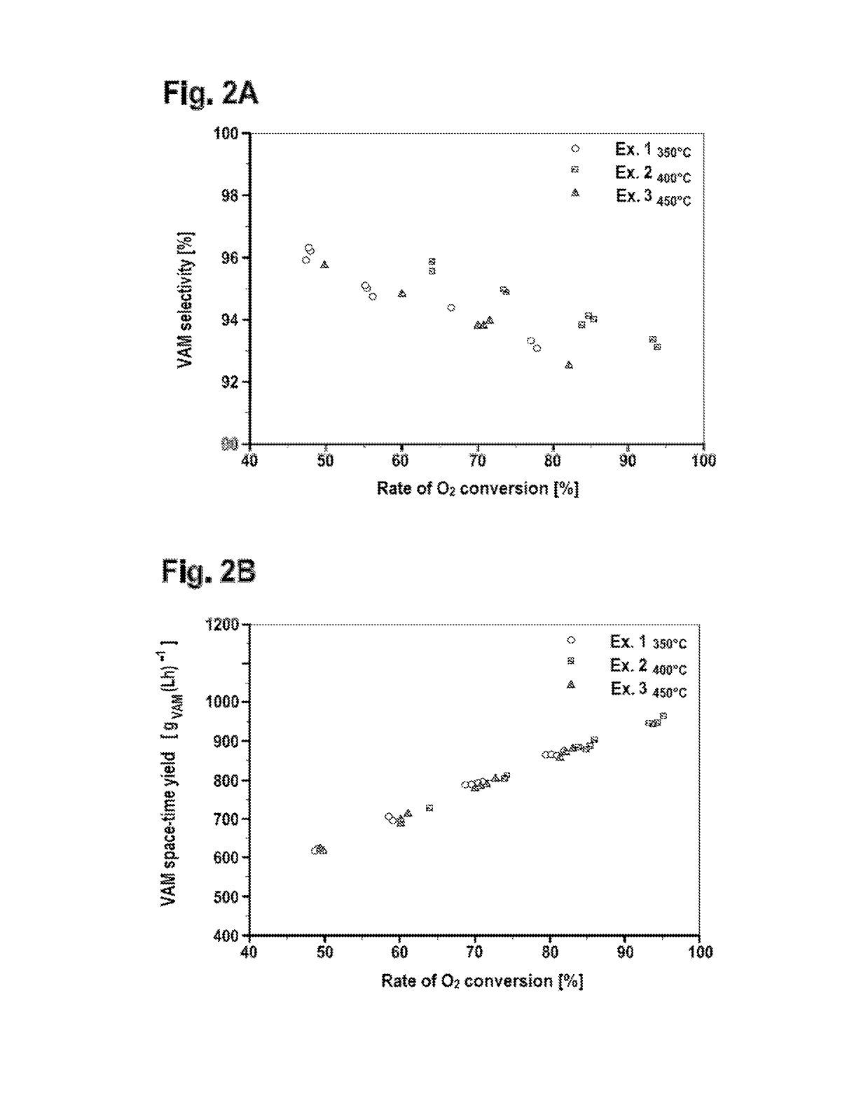

FIG. 2A results of a comparison test of the VAM selectivity of a catalyst which was produced according to an embodiment of the method according to the invention;

FIG. 2B results of a comparison test of the VAM space-time yield of the catalyst from FIG. 2A;

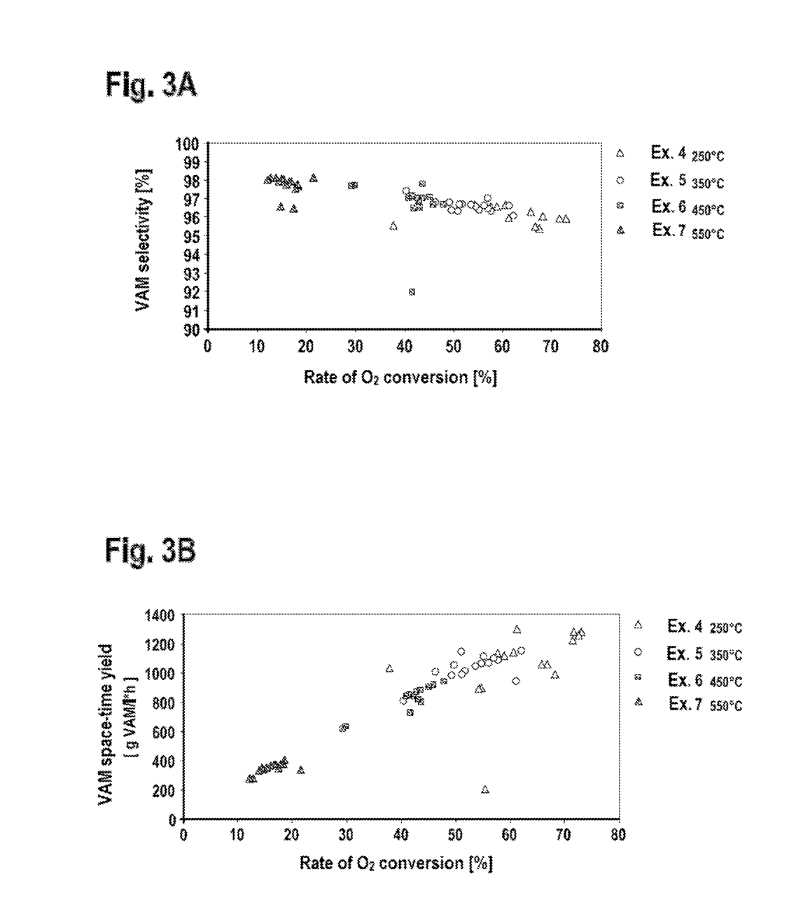

FIG. 3A results of a comparison test of the VAM selectivity of a catalyst which was produced according to another embodiment of the method according to the invention;

FIG. 3B results of a comparison test of the VAM space-time yield of the catalyst from FIG. 3A;

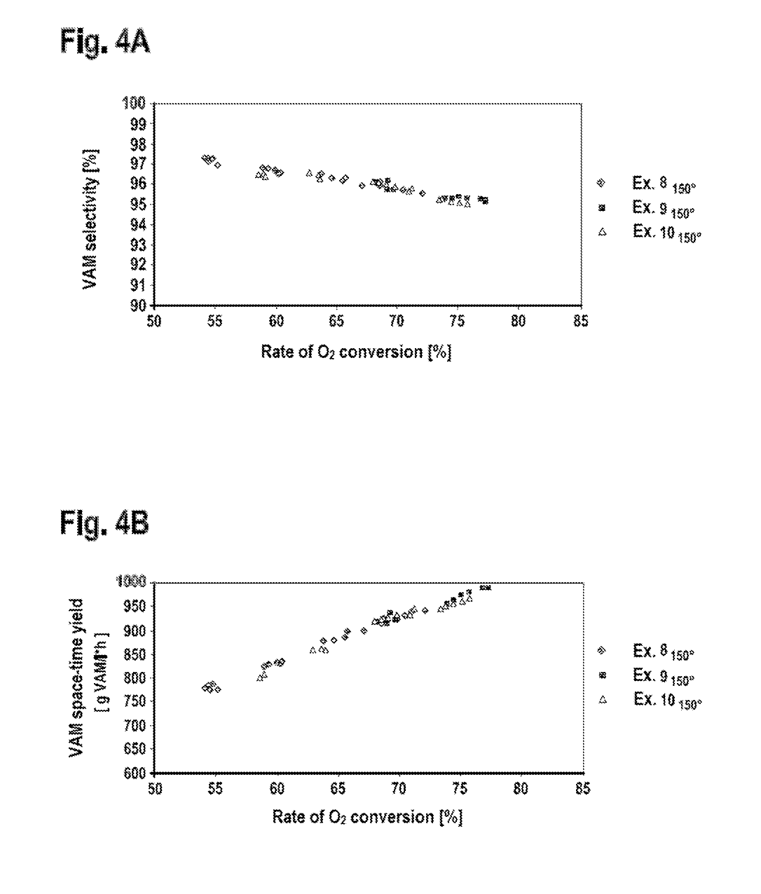

FIG. 4A results of a comparison test of the VAM selectivity of a catalyst which was produced according to a further embodiment of the method according to the invention;

FIG. 4B results of a comparison test of the VAM space-time yield of the catalyst from FIG. 4A;

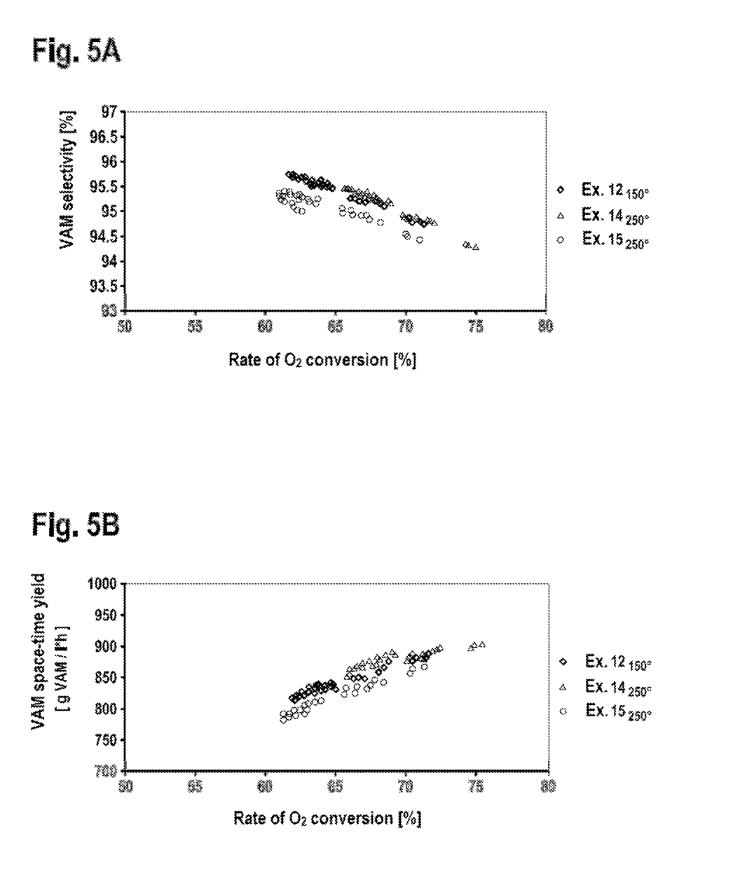

FIG. 5A results of a comparison test of the VAM selectivity of catalysts which were produced according to further embodiments of the method according to the invention;

FIG. 5B results of a comparison test of the VAM space-time yield of the catalysts from FIG. 5A;

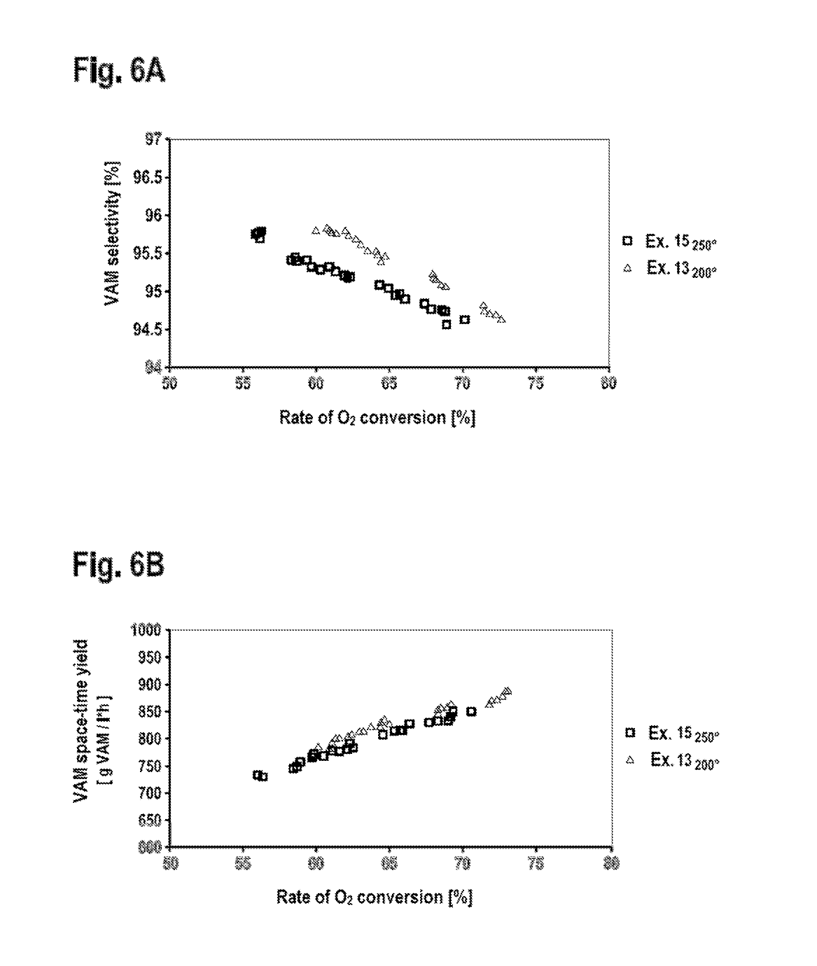

FIG. 6A results of a comparison test of the VAM selectivity of catalysts which were produced according to further embodiments of the method according to the invention;

FIG. 6B results of a comparison test of the VAM space-time yield of the catalysts from FIG. 6A;

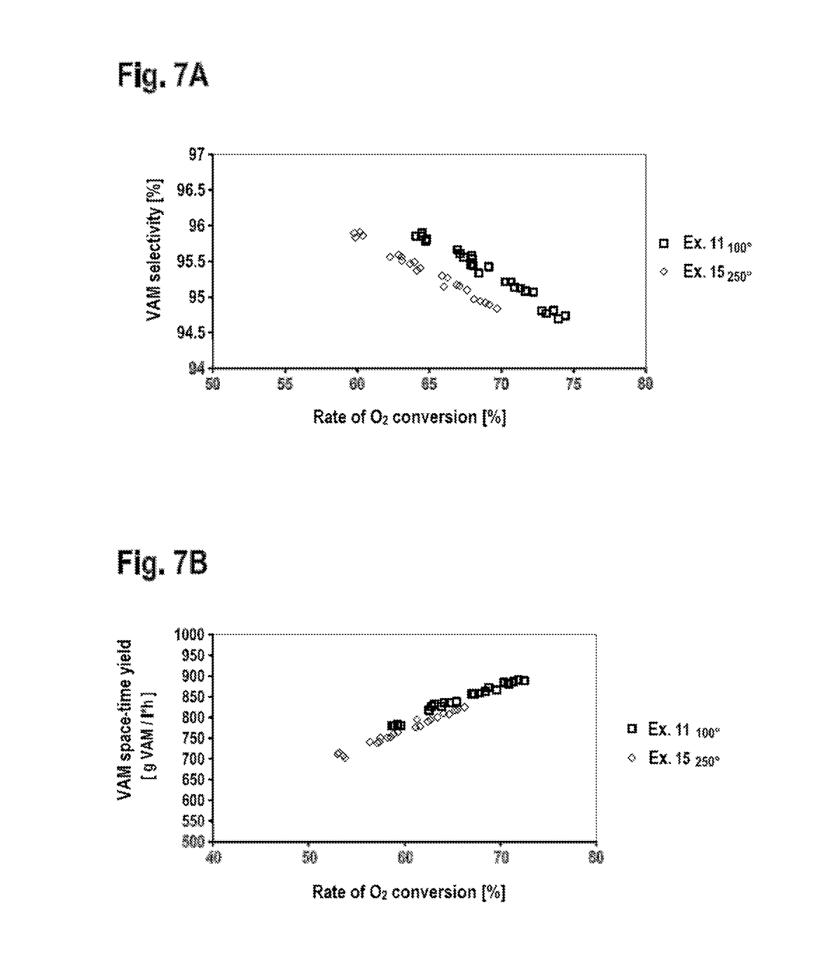

FIG. 7A results of a comparison test of the VAM selectivity of catalysts which were produced according to further embodiments of the method according to the invention;

FIG. 7B results of a comparison test of the VAM space-time yield of the catalysts from FIG. 7A;

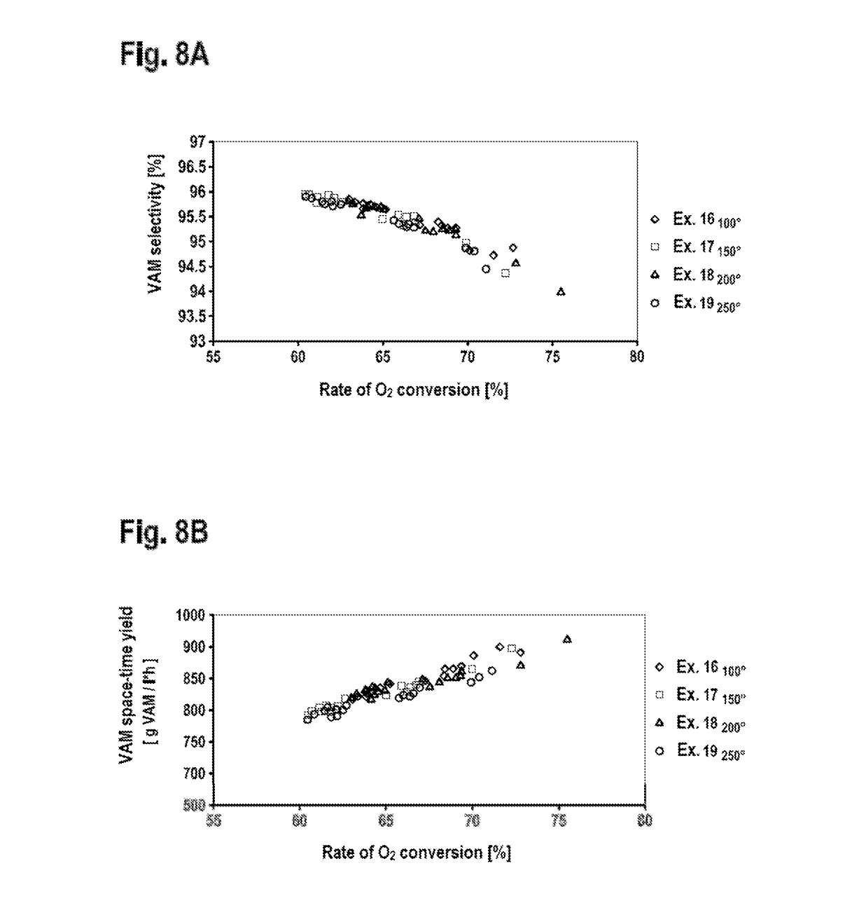

FIG. 8A results of a comparison test of the VAM selectivity of catalysts which were produced according to further embodiments of the method according to the invention; and

FIG. 8B results of a comparison test of the VAM space-time yield of the catalysts from FIG. 8A.

### EXAMPLES

### Example 1

2.4 g Na₂PdCl₄ (18.19% Pd content; 10308; Heraeus) is brought into a homogeneous solution with 0.49 g HAuCl₄ (40.64% Au content; 10708; Heraeus) and 28.48 g H2O in a mixer. After addition of 50 g KA-160 spheres (a Zr-free standard support), these were rotated for 65 min at RT, with the result that they reach a dry state. After impregnation, 65.23 g 0.44 M NaOH (produced from a 25% parent solution; Biesterfeld Graen GmbH & Co. KG) was added to the spheres and left to stand overnight at RT for 18 hours. After draining off the fixing solution, the catalyst precursor was washed with demineralized water for 23 hours at RT accompanied by continuous exchange of the water to remove Cl residues. The final value of the conductance was 16.3 μS. The catalyst was then dried in a fluid bed for 60 min at 90° C. (e.g. blower 80). In an RS system (reduction and stabilization system), the reduction took place over 5 hours at 350° C. with 5% H₂ and 95% N₂. The reduced catalyst was uniformly distributed on the spheres with a mixture of 21.00 g 2 M KOAc solution (produced on 27.02.2008; K35911720613; Merck) and 11.11 g H₂O by means of a pipette and left to stand for one hour at RT. Finally, drying takes place for 60 min at 90° C. in the fluid bed (blower 80).

Pd loading 0.82%
Au loading 0.29%
Au/Pd (atomic)=0.20

### Example 2

2.4 g Na₂PdCl₄ (18.19% Pd content; 10308; Heraeus) is brought into a homogeneous solution with 0.49 g HAuCl₄ (40.64% Au content; 10708; Heraeus) and 28.48 g H₂O in a mixer. After addition of 50 g KA-160 spheres, the same as used in Example 1, these were rotated for 65 min at RT, with the result that they reach a dry state. After impregnation, 65.23 g 0.44 M NaOH (produced from a 25% parent solution; Biesterfeld Graen GmbH & Co. KG) was added to the spheres and left to stand overnight at RT for 18 hours. After draining off the fixing solution, the catalyst precursor was washed with demineralized water for 23 hours at RT accompanied by continuous exchange of the water to remove Cl residues. The final value of the conductance was 16.3 μS. The catalyst was then dried in a fluid bed for 60 min at 90° C. (blower 80). In the RS system, the reduction took place over 5 hours at 400° C. with 5% H₂ and 95% N₂. The reduced catalyst was uniformly distributed on the spheres with a mixture of 21.00 g 2 M KOAc solution (produced on 27.02.2008; K35911720613; Merck) and 11.11 g H₂O by means of a pipette and left to stand for one hour at RT. Finally, drying takes place for 60 min at 90° C. in the fluid bed (blower 80).

Pd loading 0.81%
Au loading 0.28%
Au/Pd (atomic)=0.20

### Example 3

2.4 g Na₂PdCl₄ (18.19% Pd content; 10308; Heraeus) is brought into a homogeneous solution with 0.49 g HAuCl₄ (40.64% Au content; 10708; Heraeus) and 28.48 g H₂O in a mixer. After addition of 50 g KA-160 spheres, the same as used in Example 1, these were rotated for 65 min at RT, with the result that they reach a dry state. After impregnation, 65.23 g 0.44 M NaOH (produced from a 25% parent solution; Biesterfeld Graen GmbH & Co. KG) was added to the spheres and left to stand overnight at RT for 18 hours. After draining off the fixing solution, the catalyst precursor was washed with demineralized water for 23 hours at RT accompanied by continuous exchange of the water to remove Cl residues. The final value of the conductance was 16.3 μS. The catalyst was then dried in a fluid bed for 60 min at 90° C. (blower 80). In the RS system, the reduction took place over 5 hours at 450° C. with 5% H₂ and 95% N₂. The reduced catalyst was uniformly distributed on the spheres with a mixture of 21.00 g 2 M KOAc solution (produced on 27.02.2008; K35911720613; Merck) and 11.11 g H₂O by means of a pipette and left to stand for one hour at RT. Finally, drying takes place for 60 min at 90° C. in the fluid bed (blower 80).

Pd loading 0.82%
Au loading 0.28%
Au/Pd (atomic)=0.20

### Reactor Tests

A reaction for producing VAM was carried out with each of the catalysts of Examples 1 to 3. In each case 32 5-mm catalyst spheres (6 mL catalyst bed) were exposed to the action of a feed gas stream of 250 mL/min composed of 13% acetic acid, 6% O₂, 39% ethylene in N₂ in a fixed-bed tubular reactor in the temperature range of 140-150° C. at 8 bar and the reactor output analysed by means of GC. The selectivity of the reaction of ethylene to VAM, also called VAM selectivity or selectivity, is calculated according to the formula S=mole VAM/(mole VAM+mole CO₂/2). The space-time yield, also called STY or VAM space-time yield here, as a measure of the activity of the catalyst is expressed in g VAM/L cat*h. The rate of oxygen conversion is calculated according to (mole O₂ in−mole O₂ out)/mole O₂ in.

FIGS. 2A and 2B show that the catalyst of Example 2 has a high selectivity with an improved STY compared with the two other catalysts of Examples 1 and 3 which were reduced at different temperatures for their production. The invention makes it possible to set the STY and the selectivity of the shell catalyst in dependence on each other. For example, the STY of the catalyst can be reduced as needed and higher selectivities can be obtained for it, e.g. by increasing the temperature during the reduction of the metal precursor compound and/or by a smaller BET surface area of the catalyst. Moreover, the tests show that suitable activity and selectivity values of the finished shell catalyst are achieved with a reduction duration of 5 hours and a reduction temperature of approx. 400° C. It is furthermore shown that the reduction of the metal component of the transition-metal precursor compound can be carried out according to the invention with reciprocally correlated temperature and reduction duration. The effect of a high reduction temperature on the activity and selectivity of the catalyst to be produced can namely also be achieved for example by reduction at a comparatively low temperature and longer reduction duration.

### Examples 4 to 7

To produce the catalyst of Example 4, 34.71 g Pd(NH₃)₄(OH)₂ (3.16% Pd solution from Heraeus) and 11.72 g KAuO₂ (7.49% Au solution from Heraeus) with 150 ml H₂O were coated onto 100 g support spheres with 14% ZrO₂ (surface area of 152 m²/g, spheres with a diameter of 5 mm, with the following contents in wt.-%: Zr 11.2%, SiO₂ 76.5%; Al₂O₃ 2.9%; Fe₂O₃ 0.34%; TiO₂ 0.35%; MgO 0.15%; CaO 0.06%; K₂O 0.43%; NaO₂ 0.21%) in the Innojet Aircoater from Innojet Technologies (laboratory coater IAC025) accompanied by circulation at a temperature of 70° C. The Innojet Aircoater corresponds to the device described here with centrally arranged, concentric annular gap nozzle 50, for producing a toroidal fluidized bed. Drying then took place in the fluid bed at 90° C. (blower 80) for 45 min. Then reduction took place in the gas phase in the fixed bed with 5% hydrogen in nitrogen over 4 hours at 250° C. Lastly, the catalyst was impregnated with 23.1 g of a 2M potassium acetate solution in 43.3 g H₂O. For this, the KOAc solution was mixed with H₂O, then the catalysts were added and everything was stirred until the catalysts were dry, followed by an hour's wait and then drying at 90° C. (blower 80) for another 45 min in the fluid bed.

The catalysts of Examples 5 to 7 were produced like that of Example 4, but instead of at 250° C. the reduction took place at the following temperatures: 350° C. for Example 5; 450° C. for Example 6; and 550° C. for Example 7.

The metal loadings on the finished catalysts were in each case:

Pd loading 0.9%
Au loading 0.8%
K loading 3%

### Reactor Tests

For each catalyst of Examples 4 to 7, 5 ml catalyst bed in each case was tested in a fixed-bed tubular reactor. First, the catalysts were installed in the reactor and screwed in, then a leak test was performed to check for leaks. A pressure test was then performed to check whether the system loses gases. Then, heating took place, another pressure test was carried out and the reaction started at 140° C. The feed gas was composed of 39% ethylene, 12.5% acetic acid, 6% oxygen, 8% methane and the remainder of nitrogen. In each case, the catalyst was exposed to the action of a feed gas stream of 250 mL/min in the fixed-bed tubular reactor at 7 bar. The test was started with an oxygen ramp of 2%, 3%, 4%, 4.5%, 5%, 5.5%, 6% over 7 h. Equilibration then took place for 16 h at 140° C. and 6% O₂. Then, the catalytic efficiency was measured at reaction temperatures of 140° C.-148° C. by means of online GC.

The selectivity of the reaction of ethylene to VAM, also called VAM selectivity or selectivity, is calculated according to the formula S=mole VAM/(mole VAM+mole CO₂/2). The space-time yield, also called STY or VAM space-time yield here, as a measure of the activity of the catalyst is expressed in g VAM/L cat*h. The rate of oxygen conversion is calculated according to (mole O₂ in−mole O₂ out)/mole O₂ in.

FIGS. 3A and 3B show that the rate of conversion as a measure of the catalytic activity of the catalysts of Examples 4 to 7 falls with increasing reduction temperature during the production, without having a pronounced effect on the selectivity. The catalyst of Example 4, the precursor of which had been reduced at 250° C., has a comparatively high selectivity with improved STY compared with the other catalysts of Examples 5 to 7, which were reduced for their production at diverging and different temperatures. The invention thus makes it possible to set the STY of the shell catalyst in dependence on the reduction temperature. The STY of the catalyst can also be reduced as needed, e.g. by increasing the temperature during the reduction of the metal precursor compound and/or by a smaller BET surface area of the catalyst.

### Examples 8 to 10

As Examples 8 to 10, three further coated catalysts were produced each of which was reduced at 150° C. The catalysts of Examples 8 to 10 differ only by the potassium content, which has no influence on the selectivity, but only influences the activity.

To produce Example 8, 100 g of the same 5 mm support spheres with 14% ZrO₂, which were used in Examples 4 to 7, were coated with a mixed solution of 33.16 g of a 3.304% Pd(NH₃)₄(OH)₂ solution (obtained from Heraeus) and 16.02 g of a 4.10% KAuO₂ solution (produced by Südchemie) in 100 ml water in the Innojet Aircoater from Innojet Technologies (laboratory coater IAC025) at 70° C. and then reduced at 150° C. for 4 h with forming gas. Impregnation then takes place in a rotating piston with an aqueous potassium-acetate solution for 1 h until incipient wetness is achieved. The metal loadings on the finished catalyst were 1.0% Pd and 0.6% Au.

The catalyst of Example 9 was also produced as in Example 8, but coated with a mixed solution of 33.16 g 3.304% Pd(NH₃)₄(OH)₂ solution and 8.77 g 7.49% KAuO₂ solution.

The catalyst of Example 10 was produced like that of Example 8, but coated with a mixed solution of 33.16 g 3.304% Pd(NH₃)₄(OH)₂ solution and 14.38 g 4.57% KAuO₂ solution.

Due to the potassium-aurate solutions used, the catalysts produced of Examples 8 to 10 differ only in the potassium content. The commercial Heraeus solution is rich in potassium, with a K content of approx. 7.5%, and was used for Example 9. The solution produced by Südchemie is poor in potassium with a K content of 1.15%. For Example 10, a 1:1 mixture of these two aurate solutions was used.

Reactor tests were then carried out as in Examples 4 to 7 to check the catalytic efficiency. The results of this reactor test are shown in FIGS. 4A and 4B. The overview of FIGS. 1A to 4B shows that the reduction at 150° C. leads to more active and selective catalysts compared with higher reduction temperatures.

### Examples 11 to 15

To produce the catalysts of Examples 11 to 13, 663.30 g Pd (NH₃)₄(OH)₂ (3.30% Pd solution from Heraeus) and 261.10 g KAuO₂ (5.03% Au solution from Heraeus) with 150 ml H₂O were coated onto 2000 g KA support spheres with 14% ZrO₂ (surface area of 152 m²/g, spheres with a diameter of 5 mm, with the following contents in wt.-%: Zr 11.2%, SiO₂ 76.5%; Al₂O₃ 2.9%; Fe₂O₃ 0.34%; TiO₂ 0.35%; MgO 0.15%; CaO 0.06%; K₂O 0.43%; NaO₂ 0.21%) in the pilot coater of the Aircoater05 type from Innojet Technologies accompanied by circulation at a temperature of 70° C. The Innojet Aircoater05 corresponds to the device described here, for producing a toroidal fluidized bed. Reduction then took place in the gas phase in the fixed bed with 5% hydrogen in nitrogen over 4 hours at 100° C., 150° C., 200° C. and 250° C. respectively, in order to obtain the catalysts of Examples 11 (100° C.), 12 (150° C.), 13 (200° C.) and 14 (250° C.). Lastly, the catalyst was impregnated with 410.20 g of a 2M potassium acetate solution in 843.76 g H₂O. For this, the KOAc solution was mixed with H₂O, then the catalysts were added and everything was stirred until the catalysts were dry, followed by an hour's wait and drying at 90° C. (blower 80) for 45 min in the fluid bed.

The metal loadings on the finished catalysts were in each case:

Pd loading 1.0%
Au loading 0.6%
K loading 2.8%

The catalyst of Example 15 was produced like the catalyst of Example 9 in the laboratory coater, with the exception of the reduction temperature, which was 250° C. here.

Reactor tests were then carried out as in Examples 4 to 7 to check the catalytic efficiency. The results of this reactor test are shown in FIGS. 5A to 7B. It can be seen from FIGS. 5A to 5B that in the pilot coater the reductions at 250° C. and 150° C. lead to more active and selective catalysts compared with Example 15 (laboratory coater, reduction at 250° C.). Examples 12 and 14 (pilot coater, reductions at 150° C. and 250° C.) show the same performance within the limits of experimental measurement error. It follows from FIGS. 6A and 6B that in the pilot coater the reduction at 200° C. leads to a more active and selective catalyst compared with the catalyst of Example 15 with a reduction temperature at 250° C. in the laboratory coater. FIGS. 7A and 7B show that in the pilot coater the reduction at 100° C. leads to a more active and selective catalyst compared with the catalyst of Example 15 with a reduction temperature at 250° C. in the laboratory coater.

### Examples 16 to 19

To produce the catalysts of Examples 16 to 19, 663.30 g Pd (NH₃)₄(OH)₂ (3.30% Pd solution from Heraeus) and 261.10 g KAuO₂ (5.03% Au solution from Heraeus) with 150 ml H₂O were coated onto 2000 g KA support spheres with 14% ZrO₂ (surface area of 152 m²/g, spheres with a diameter of 5 mm, with the following contents in wt.-%: Zr 11.2%, SiO₂ 76.5%; Al₂O₃ 2.9%; Fe₂O₃ 0.34%; TiO₂ 0.35%; MgO 0.15%; CaO 0.06%; K₂O 0.43%; NaO₂ 0.21%) in the pilot coater of the Aircoater05 type from Innojet Technologies accompanied by circulation at a temperature of 70° C. The Innojet Aircoater05 corresponds to the device described here, for producing a toroidal fluidized bed. Reduction then took place in the gas phase in the fixed bed with 5% hydrogen in nitrogen over 4 hours at 100° C., 150° C., 200° C. and 250° C. respectively, in order to obtain the catalysts of Examples 16 (100° C.), 17 (150° C.), 18 (200° C.) and 19 (250° C.). Lastly, the catalyst was impregnated with 410.20 g of a 2M potassium acetate solution in 843.76 g H₂O. For this, the KOAc solution was mixed with H₂O, then the catalysts were added and everything was stirred until the catalysts were dry, followed by an hour's wait and drying at 90° C. (blower 80) for 45 min in the fluid bed.

The metal loadings on the finished catalysts were in each case:

Pd loading 1.0%
Au loading 0.6%
K loading 2.8%

Reactor tests were then carried out as in Examples 4 to 7 to check the catalytic efficiency. The four catalysts of Examples 16 to 19 were tested in direct comparison. The results of this reactor test are shown in FIGS. 8A and 8B.

It can be seen from FIGS. 8A and 8B that the differences in performance are very small, i.e. the H₂ gas-phase reduction in the temperature range from 100° C. to 250° C. leads to excellent catalysts. The catalyst of Example 19 reduced at 250° C. is somewhat less selective than the other three catalysts. The performance of the catalysts of Examples 17 to 19 reduced at 100° C., 150° C. and 200° C. is comparable.

For process-engineering reasons, a preferred reduction temperature is 100° C., in order to make possible an in-situ H₂ reduction in the coater during and/or after the noble-metal coating. A further preferred reduction temperature is 150° C., as the reactors are operated on a large scale at approx. 150° C. and the catalysts are exposed to a minimum of thermal stress at 150° C.

1.-17. (canceled)

18. Method for producing a shell catalyst which comprises a porous catalyst support shaped body with an outer shell in which at least one transition metal in metal form is contained, using a device (10) which is set up to cause a circulation of the catalyst support shaped bodies by means of a process gas (40), comprising
providing catalyst support shaped bodies, comprising charging the device (10) with the catalyst support shaped bodies and causing a circulation of the catalyst support shaped bodies by means of the process gas (40);
applying a transition-metal precursor compound to an outer shell of the catalyst support shaped bodies, comprising spraying the outer shell of the circulating catalyst support shaped bodies with a solution containing the transition-metal precursor compound at a temperature of from 60° C. to 90° C.; and
following the application, converting the metal component of the transition-metal precursor compound into the metal form by reduction in the process gas at a temperature of from 50° C. to 140° C., preferably 80° C. to 120° C., wherein the temperature and the duration of the reduction are chosen such that the product of reduction temperature in ° C. and reduction time in hours lies in a range of from 50 to 1500.

19. Method according to claim 18,
wherein the reduction takes place in the process gas in a temperature range of from 100° C. to 150° C.;
and/or
wherein the reduction is carried out for 1 to 10 hours or 5 hours;
and/or
wherein the reduction is carried out with reciprocally correlated temperature and reduction duration; and/or
wherein der quotient T/t of reduction temperature T in ° C. and reduction time t in hours lies in a range of from 5 to 150 or 20 to 30.

20. Method according to claim 18, wherein
the process gas comprises a gas which is selected from the group which consists of an inert gas, a gas mixture of an inert gas and a component with a reductive effect, and forming gas.

21. Method according to claim 18,
wherein the application of the transition-metal precursor compound takes place by spraying with a solution containing the transition-metal precursor compound and a solvent at temperatures greater than room temperature and accompanied by continuous evaporation of the solvent.

22. Method according to claim 18, wherein the process gas is an inert gas.

23. Method according to claim 18, wherein the process gas comprises forming gas, and the conversion of the metal component of the transition-metal precursor compound into the metal form is carried out by reduction with the forming gas at a temperature of from 50° C. to 150° C.

24. Method according to claim 23, wherein the reduction is carried out with forming gas with reciprocally correlated temperature and reduction duration, in a temperature range of from 50° C. to 150° C. and a range of the reduction duration of from 10 hours to 1 hour.

25. Method according to claim 18, wherein a fluid bed or a fluidized bed or a toroidally circulating fluidized bed of catalyst support shaped bodies in which the shaped bodies are circulated is produced by means of the process gas.

26. Method according to claim 18, characterized in that the catalyst support shaped body is formed based on a silicon oxide, aluminium oxide, zirconium oxide, titanium oxide, niobium oxide or a natural sheet silicate, in particular a calcined acid-treated bentonite.

27. Method according to claim 18, wherein the solution of the transition-metal precursor compound contains as transition-metal precursor compound at least one compound selected from the group consisting of: a noble-metal compound, a Pd compound, an Au compound, an Ag compound, a Pt compound, an Ni, Co and/or Cu compound.

28. Method according to claim 18, wherein a promoter compound is applied before or after the conversion of the metal component of the transition-metal precursor compound into the metal form.

29. Method according to claim 18, wherein the inert gas is selected from the group consisting of nitrogen, carbon dioxide and the noble gases, preferably helium and argon, or is a mixture of two or more of the above-named gases.

30. Method according to claim 18, wherein the component with a reductive effect is selected from the group consisting of ethylene, hydrogen, CO, NH₃, formaldehyde, methanol and hydrocarbons, or is a mixture of two or more of the above-named compounds.

31. Shell catalyst, obtainable by a method according to claim 18.

32. Catalyst according to claim 31, wherein the shell of the catalyst has a thickness smaller than 400 μm, preferably smaller than or equal to 300 μm, by preference smaller than 250 μm, further preferably smaller than 200 μm and more preferably smaller than 150 μm.

33. Use of a shell catalyst according to claim 31 in a method for producing vinyl acetate monomer.

34. A method according to claim 18, wherein the method is conducted in a device (10) which is set up to cause a circulation of the catalyst support shaped bodies by means of a process gas (40).
